(19) United States
(12) Patent Application Publication
(10) Pub. No.: US 2024/0079622 A1
(43) Pub. Date: Mar. 7, 2024

(54) METAL-CONTAINING POLYMERIC ION CONDUCTORS

(71) Applicant: Technion Research & Development Foundation Limited, Haifa (IL)

(72) Inventors: Charles Eliezer DIESENDRUCK, Haifa (IL); Dario R. DEKEL, Haifa (IL)

(73) Assignee: Technion Research & Development Foundation Limited, Haifa (IL)

(21) Appl. No.: 18/270,020

(22) PCT Filed: Dec. 31, 2021
(86) PCT No.: PCT/IL2021/051563

§ 371 Date: Jun. 28, 2023

Related U.S. Application Data
(60) Provisional application No. 63/132,552, filed on Dec. 31, 2020.

(51) Int. Cl. H01M 8/1023; H01M 8/1067

(52) U.S. Cl. CPC H01M 8/1023; H01M 8/1067; H01M 2008/1095

(57) ABSTRACT

Polymeric ion conductors composed of a polymeric or co-polymeric backbone which comprises a plurality of backbone units, a metal ligand attached to at least a portion of the backbone units, and a metal ion attached to the metal ligand are provided. The metal ligand can be an N-heterocyclic carbene ligand and the metal can feature low oxophilicity. lonomeric materials, including, for example, ion exchange membranes such as anion exchange membranes, made of the polymeric ion conductor, and electrochemical systems and articles-of-manufacturing containing the polymeric ion conductor or the ion exchange membrane are also provided.

### RELATED APPLICATION/S

This application claims the benefit of priority under 35 USC § 119(e) of U.S. Provisional Patent Application No. 63/132,552 filed Dec. 31, 2020, the contents of which are incorporated herein by reference in their entirety.

### FIELD AND BACKGROUND OF THE INVENTION

The present invention, in some embodiments thereof, relates mainly to energy conversion and, more particularly, but not exclusively, to newly designed metal-containing polymeric ion conductors (metallopolymer ion conductors), to ion exchange membrane comprising same and to electrochemical systems such as fuel cells comprising ion exchange membranes.

Over the recent decades, renewable energy sources have slowly become more present given their lower environmental impact. Considering factors such as transportation and energy density, one of the most suitable ways to store this energy is by converting it into chemical feedstocks such as hydrogen and methanol.

Fuel cells (FCs) can use these feedstocks for generation of electricity when needed. FCs have been considered as one of the most efficient and pollution free power generation technology, being not only “pollution-free” but also capable of manifesting more than twice the efficiency of traditional combustion technologies.

Ion exchange membranes are a key component of and in numerous energy storage and conversion devices. They play important roles, including separation between anode and cathode, ion transportation, fuel separation and deterrence of impurities.

Several inorganic (e.g. ceramics) as well as organic polymeric membranes have been developed and studied, and each present unique advantages and limitations.

Currently, proton exchange membrane fuel cells (PEMFCs) present an efficient method for providing power in various applications, ranging from automotive transportation to portable power generation. However, the extensive commercialization of PEMFCs remains a challenge due to their high cost and limited durability.

Anion exchange membrane fuel cells (AEMFCs) are an expedient alternative to PEMFCs and are currently gathering modernized attention. A schematic illustration of an exemplary AEMFC is shown in Background Art FIG. 1A. AEMFCs are currently hindered by the challenging requirements of the anion exchange membrane (AEM): good thermal and mechanical stability, high hydroxide ion conductivity, and long-term durability at elevated temperatures under strong alkaline conditions.

Generally, AEMs are composed of an organic polymer backbone covalently bound to cationic groups, either as side chains, as schematically exemplified in FIG. 1B or as part of the backbone.

Quaternary ammonium salts (QAs) have been the most explored cations for this application, given their relatively high stability to alkaline conditions compared to the more oxophilic phosphonium and sulfonium cations [Luo et al. (2018) J. Memb. Sci. 555, 429-454; Gu et al. (2009) Angew. Chem. Int. Ed. 48, 6499-6502; Noonan et al. (2012) J. Am. Chem. Soc. 134, 18161-18164; Zhang et al. (2012) RSC Adv. 2, 12683-12685]. However, while hydroxide (OH⁻) is the conducting anion in AEMs, the hydroxide anion is at the same time responsible for the degradation of the functionalized polymer, posing a so far unsolvable challenge, as no membrane currently can sustain the required operating conditions for sufficient time, and at the desired power.

An underexploited alternative to the QAs are metallopolymers (metal-containing polymers). If adequately designed, metallopolymers can combine the best qualities of organic and inorganic materials—excellent mechanical properties and chemically stable ionic species for ion-conductance [Zhu et al. (2018) Nat. Commun. 9, 4329].

In the last decade, the synthesis of metallopolymers has skyrocketed and their advantages have been demonstrated in different material applications such as water purification, sensors, light-emitting devices and also some energy-related uses, such as solar cells [Alabi et al. (2018) npj Clean Water 1, 10; Vidaysky et al. (2018) J. Polym. Sci. Part A Polym. Chem. 56, 1117-1122; Knapton et al. (2006) Angew. Chem. Int. Ed. 45, 5825-5829; Chen et al. (2015) J. Am. Chem. Soc. 137, 11590-11593].

Metal-containing polymers have been fabricated with a wide range of metals, ligands and counter-ions and have been studied for their optoelectronic, magnetic and thermochromic properties [Winter, A. and Schubert, U.S. (2020) ChemCatChem 12, 2890-2941].

A few examples of metallopolymers as AEMs for AEMFCs were put forward, presenting reasonably good initial results. Yet, similarly to membranes based on organic polymers, these metallopolymer-based membranes lost their activity after a relatively short time [see, for example, Kwasny, M. T., and Tew, G. N. (2017) J. Mater. Chem. A 5, 1400-1405; Zha et al. (2012) J. Am. Chem. Soc. 134, 4493-4496; Disabb-Miller et al. Macromolecules 2013, 46 (23), 9279-9287; Kwasny et al. J. Am. Chem. Soc. 2018, 140 (25), 7961-7969].

Exemplary such metallopolymers were prepared using a tridentate ligand connected to a norbornene monomer, which was polymerized by ring-opening metathesis polymerization (ROMP), connected to ruthenium (II) ions, and later on to other metal ions such as nickel and cobalt, and cross-linked using dicyclopentadiene (DCPD). These metallopolymers showed good chemical stability in aqueous hydroxide-containing solutions, but low conductivity and rapid conductivity loss, given the strong binding between the metal and the hydroxide anion. Notably, the chemical stability of these metallopolymers was tested in protic solvents, which do not represent the typically aggressive conditions in operating fuel cells. The practiced ROMP polymers provide good mechanical properties but limited water uptake, which is also an important factor for providing improved hydroxide conductivity.

Cationic metallo-polyelectrolytes designed for anion-exchange membranes (AEMs) via ring-opening metathesis polymerization (ROMP) of cobaltocenium-containing cyclooctene with triazole as the linker group, followed by backbone hydrogenation, have been reported in U.S. Patent Application Publication No. 2019/0099723 and in Zhu et al. (2018) Angew. Chem. Int. Ed. 57, 2388-2392.

U.S. Patent Application Publication No. 2009/0227740 describes poly(NHC)s and metal complexes thereof.

Additional background art includes Gu et al. Macromolecules 47, 208-216; and WO 2014/058849.

### SUMMARY OF THE INVENTION

According to an aspect of some of any of the embodiments of the invention, there is provided a polymeric ion conductor comprising a polymeric or co-polymeric backbone which comprises a plurality of backbone units, a metal ligand attached to at least a portion of the backbone units, and a metal ion attached to the metal ligand, wherein the metal features an oxophilicity lower than 0.4, or lower than 0.3, or lower than 0.2, when calculated according to metal-oxygen bond enthalpy.

According to an aspect of some of any of the embodiments of the invention, there is provided a polymeric ion conductor comprising a polymeric or co-polymeric backbone which comprises a plurality of backbone units, a metal ligand attached to at least a portion of the backbone units, and a metal ion attached to the metal ligand, wherein the metal ligand comprises at least one N-heterocyclic carbene moiety.

According to an aspect of some of any of the embodiments of the invention, there is provided an anion conducting composition comprising a polymeric ion conductor according to any of the embodiments described herein and a cyclic moiety associated therewith.

According to an aspect of some of any of the embodiments of the invention, there is provided an anion exchange membrane comprising a polymeric ion conductor according to any of the embodiments described herein or an anion conducting composition according to any of the embodiments described herein.

According to an aspect of some of any of the embodiments of the invention, there is provided an electrochemical system comprising a polymeric ion conductor according to any of the embodiments described herein, an anion conducting composition according to any of the embodiments described herein, or an anion exchange membrane according to any of the embodiments described herein.

According to an aspect of some of any of the embodiments of the invention, there is provided an article-of-manufacturing comprising a polymeric ion conductor according to any of the embodiments described herein, an anion conducting composition according to any of the embodiments described herein, an anion exchange membrane according to any of the embodiments described herein, or an electrochemical system according to any of the embodiments described herein.

According to some embodiments of any of the embodiments of the invention, the metal is selected from nickel (Ni), zinc (Zn), palladium (Pd), lead (Pb), silver (Ag), cadmium (Cd), platinum (Pt) and gold (Au).

According to some embodiments of any of the embodiments of the invention, the metal is gold (Au).

According to some embodiments of any of the embodiments of the invention, the polymeric ion conductor further comprises a counter ion.

According to some embodiments of any of the embodiments of the invention, the metal ligand is attached to the backbone units as a pendant group and/or as a part of the backbone.

According to some embodiments of any of the embodiments of the invention, the ligand is a monodentate ligand or a multidentate ligand.

According to some embodiments of any of the embodiments of the invention, the ligand comprises at least one N-heterocyclic carbene moiety.

According to some embodiments of any of the embodiments of the invention relating to an N-heterocyclic carbene moiety, the metal features an oxophilicity lower than 0.4, or lower than 0.3, or lower than 0.2, when calculated according to metal-oxygen bond enthalpy.

According to some embodiments of any of the embodiments of the invention relating to an N-heterocyclic carbene moiety, the metal is selected from ruthenium (Ru), cobalt (Co), copper (Cu), nickel (Ni), zinc (Zn), palladium (Pd), lead (Pb), silver (Ag), cadmium (Cd), platinum (Pt) and gold (Au).

According to some embodiments of any of the embodiments of the invention relating to an N-heterocyclic carbene moiety, the N-heterocyclic carbene moiety is represented by general Formula I:

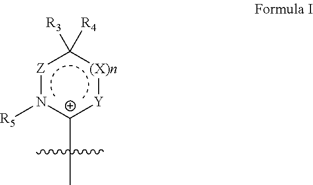

wherein:

the dashed line indicates an optional unsaturated bond;
X is —CR₆R₇—CR₈R₉— and/or —CR₁₀═CR₁₁—;
n is 0, 1 or 2, representing the number of X;
Y is —CR₁₂R₁₃—, —NR¹⁴—, —S—, —O—, or absent;
Z is —CR₁R₂—, —NR₁₅—, —S—, —O—, or absent;

R₁, R₃, R₅ and R₁₅ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or is absent in case the atom substituted thereby is linked to an adjacent atom via a double bond, or, alternatively, one of R₁, R₃, R₅ and R₁₅ is a linking moiety or a bond linking the heterocyclic moiety to a backbone unit of the polymeric backbone;

R₂, R₄, R₁₂, R₁₃ and R₁₄ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or alternatively, one of R₂, R₄, R₁₂, R₁₃ and R₁₄ is a linking moiety or a bond linking the heterocyclic moiety to a backbone unit of the polymeric backbone;

R₆, R₇, R₈, R₉, R₁₀ and R₁₁ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or, alternatively, one of R₆, R₇, R₈, R₉, R₁₀ and R₁₁ is a linking moiety or a bond linking the heterocyclic moiety to a backbone unit of the polymeric backbone;
and
the curved line represents an attachment point to the metal ion,
wherein at least two of R₁-R₁₅ may form a cyclic or heterocyclic ring, and
wherein at least one of R₁-R₁₅ is the abovementioned linking moiety or bond linking the heterocyclic moiety to a backbone unit of the polymeric backbone.

According to some embodiments of any of the embodiments of the invention relating to Formula I, the N-heterocyclic carbene moiety comprises at least one unsaturated bond indicated by the dashed line.

According to some embodiments of any of the embodiments of the invention relating to Formula I, the N-heterocyclic carbene moiety comprises an aromatic ring which includes Y and Z.

According to some embodiments of any of the embodiments of the invention relating to Formula I, n is 0 and Y is —NR₁₄—.

According to some embodiments of any of the embodiments of the invention relating to Formula I, the N-heterocyclic carbene moiety is represented by Formula 1a:

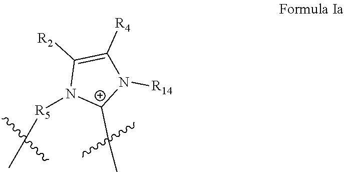

wherein R₅ is the linking moiety and the curved line next to R₅ represents an attachment point to the backbone unit.

According to some embodiments of any of the embodiments of the invention relating to Formula I, R₅ is an alkylene.

According to some embodiments of any of the embodiments of the invention relating to Formula I, R₁₄ is an aryl.

According to some embodiments of any of the embodiments of the invention relating to

Formula I, the N-heterocyclic carbene moiety comprises a saturated heteroalicyclic ring which includes Y and Z, and Y is —CR₁₄—.

According to some embodiments of any of the embodiments of the invention, the ligand comprises at least one nitrogen-containing heterocyclic moiety, being independently substituted or unsubstituted, and a nitrogen atom of the nitrogen-containing heterocyclic moiety is coordinated to the metal.

According to some embodiments of any of the embodiments of the invention relating to a ligand comprising at least one nitrogen-containing heterocyclic moiety, the ligand comprises a substituted or unsubstituted pyridine moiety.

According to some embodiments of any of the embodiments of the invention relating to a ligand comprising at least one nitrogen-containing heterocyclic moiety, the ligand is a multidentate ligand which comprises at least two nitrogen-containing heterocyclic moieties, each being independently substituted or unsubstituted.

According to some embodiments of any of the embodiments of the invention relating to a multidentate ligand, the multidentate ligand comprises at least two pyridine moieties, each being independently substituted or unsubstituted.

According to some embodiments of any of the embodiments of the invention relating to a multidentate ligand, the multidentate ligand comprises two or three pyridine moieties, each being independently substituted or unsubstituted.

According to some embodiments of any of the embodiments of the invention relating to a ligand comprising at least one nitrogen-containing heterocyclic moiety, the polymeric ion conductor comprises no more than one type of nitrogen-containing heterocyclic moiety.

According to some embodiments of any of the embodiments of the invention, the polymeric or copolymeric backbone comprises backbone units of one or more polymer selected from the group consisting of a polynorbornene, polystyrene, polyethylene, polytetrafluoroethylene (PTFE), polypropylene, polyethylene imide (PEI), polyimide (PI), poly(ethylene-tetrafluoroethylene) (ETFE), poly(biphenyl alkylene) (PBPA), polyether, epoxy polymerpoly(ethylene oxide) (PEO), poly(phenylene oxide) (PPO), polysulfone, poly(benzimidazole) (PBI) and poly(phenylene) (PP).

According to some embodiments of any of the embodiments of the invention, the polymeric or copolymeric backbone comprises in at least a portion thereof backbone units of a polystyrene or a polynorbornene.

According to some embodiments of any of the embodiments of the invention, less than 20%, or less than 10%, of the metal ions dissociate therefrom when the polymeric ion conductor is exposed to extreme alkaline conditions.

According to some embodiments of any of the embodiments of the invention relating to an anion conducting composition, the cyclic moiety is mechanically interlocked around at least a portion of the ion conductor.

According to some embodiments of any of the embodiments of the invention relating to an anion conducting composition, the polymeric matrix comprises at least one end-capping moiety at a backbone terminus thereof and/or at a pendant group terminus thereof, and being threaded within a cyclic moiety, wherein the end-capping moiety has a volume larger than a volume of the cyclic moiety to thereby have the cyclic moiety mechanically interlocked around at least a portion of the ion conductor.

According to some embodiments of any of the embodiments of the invention relating to an anion conducting composition, the cyclic moiety is a heterocyclic moiety.

According to some embodiments of any of the embodiments of the invention relating to an anion conducting composition comprising a heterocyclic moiety, the heterocyclic moiety comprises at least one electronegative heteroatom.

According to some embodiments of any of the embodiments of the invention relating to an anion conducting composition, the cyclic moiety comprises at least 12, or at least 16, or at least 18, carbon atoms.

According to some embodiments of any of the embodiments of the invention relating to an anion conducting composition, the cyclic moiety is a crown ether.

According to some embodiments of any of the embodiments of the invention relating to an electrochemical system, the electrochemical system is a fuel cell.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1C present a schematic illustration of an exemplary anion exchange membrane fuel cell (AEMFC), which utilizes hydrogen as a fuel (FIG. 1A, Background Art; taken from D. R. Dekel, J. Power Sources. 375 (2018) 158-169); a schematic illustration of AEM with different cationic sites (FIG. 1B); and a schematic illustration of “hydroxide attack” towards exemplary cationic sites: a quaternary ammonium group (FIG. 1C, left) and a positively charged metal (FIG. 1C, right).

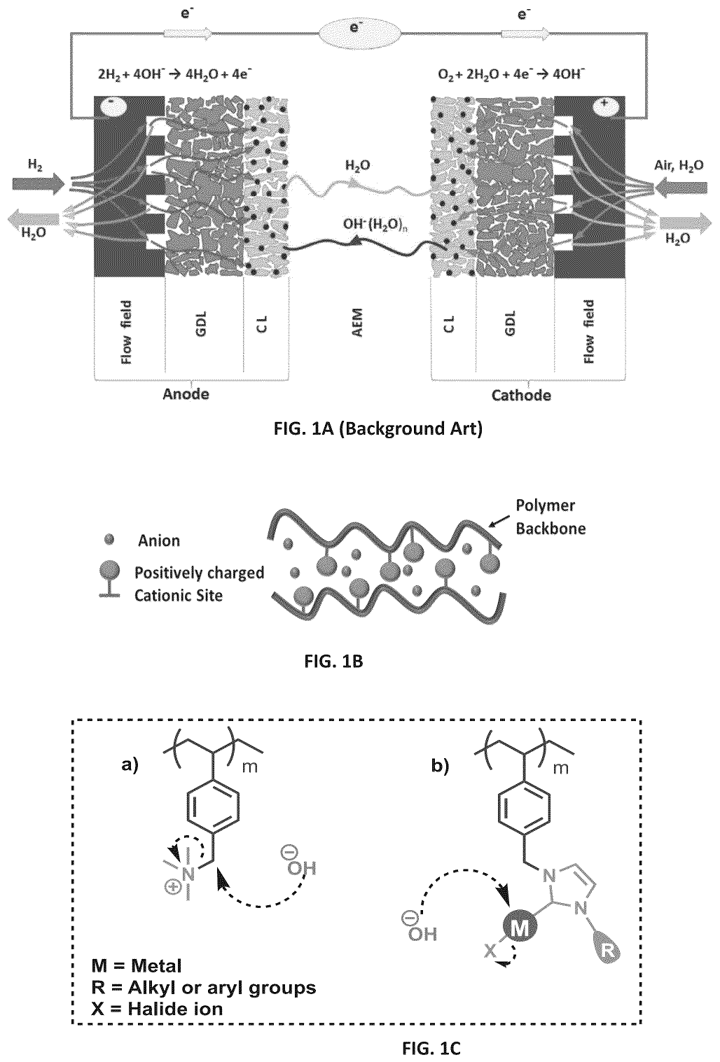

FIG. 2 presents a synthesis of poly(styrene-co-vinylbenzylchloride) (pSt-VBC), an exemplary N-heterocyclic carbene (NHC) based polymer, of an exemplary ligand precursor (1-mesitylimidazole), of an exemplary imidazolium functionalized pSt-VBC and its coordination with exemplary metals: Cu, Au, Zn and Ni, to form exemplary metallopolymers according to some embodiments of the present invention.

FIGS. 3A-3B present comparative plots showing the stabilities of exemplary metallopolymers according to some embodiments of the present invention, evaluated by measuring metal remained vs. time in 7:3 MeOH/H₂O, 3 M NaOH at 80° C. (FIG. 3A), and in an extremely dry KOH in 18-crown-6 followed by dissolution in dry DMSO (0.5 M) at room temperature (FIG. 3B).

FIG. 4 presents OH⁻ conductivities at different temperatures, measured with a gold-coordinated imidazolium functionalized pSt-VBC membrane test system (MTS 740, Scribner Associates Inc.) using a continuous 500 cm³ min⁻¹ gas flow containing nitrogen (99.999% N₂) and 95% relative humidity (RH).

FIGS. 5A-5B present the performance of a H₂/O₂ AEMFC containing an exemplary pSt-NHC-Au membrane at a cell temperature of 65° C. (FIG. 5A) and of 45, 50, 55 and 60° C. (FIG. 5B).

FIG. 6 presents a schematic depiction of a synthesis of exemplary nickel-containing metallopolymers from hydroxymethyl norbornene (1) and various halogen-substituted pyridines (ArX).

FIGS. 7A-7B present comparative plots showing the stabilities of exemplary metallopolymers according to some embodiments of the present invention, evaluated by measuring metal remained vs. time in 7:3 methanol/H₂O, 3 M NaOH at 80° C. (FIG. 7A), and in harsh conditions of extremely dry KOH in 18-crown-6 followed by dissolution in dry DMSO (0.5 M) at room temperature (FIG. 7B).

FIG. 8 presents a schematic depiction of a synthesis of exemplary gold-containing metallopolymers by reacting a various nitrogen-containing ligands (L) with a copolymer (pSt-VBC) of styrene (St) and vinylbenzyl chloride (VBC).

FIG. 9 presents comparative plots showing the stabilities of exemplary metallopolymers according to some embodiments of the present invention, evaluated by measuring metal remained vs. time in dry KOH in 18-crown-6 followed by dissolution in dry DMSO (0.5 M) at room temperature.

FIGS. 10A-10B present chloride-ion conductivity tests of exemplary metallopolymers according to some embodiments of the present invention. FIG. 10A presents Nyquist plots obtained for the exemplary metallopolymers. ‘Im’ and ‘Re’ represent the imaginary and real part of the impedance. FIG. 10B presents chloride ion conductivity of the metallopolymers at 60° C. and RH 80%.

### DESCRIPTION OF SPECIFIC EMBODIMENTS OF THE INVENTION

The present invention, in some embodiments thereof, relates mainly to energy conversion and, more particularly, but not exclusively, to newly designed metallopolymers, to ion-exchange membrane comprising same and to electrochemical systems and other articles-of-manufacturing comprising such metallopolymers, membranes or electrochemical systems, and methods utilizing same.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As discussed hereinabove, anion exchange membrane fuel cells (AEMFCs) are promising energy conversion devices due to their high efficiency and relatively low cost. Nonetheless, AEMFC operation time is currently limited by the low chemical stability of the polymeric anion-exchange membrane components therein.

In recent years, metallopolymers, in which the metal centers take the ion transport function, have been proposed as a chemically stable alternative.

The present inventors have conceived using metals that exhibit low oxophilicity and have conducted a systematic study using an organic polymer backbone with an N-heterocyclic carbene (NHC) ligand complexed to different low oxophilicity metals, such as zinc, nickel and gold. As shown in the Examples section that follows, the gold-metallopolymer demonstrates an exceptional alkaline stability, superior even to that of the state-of-the-art quaternary ammonium cations. These results demonstrate that metallopolymers may be superior to purely organic membranes and provide a scientific base for further developments in the field.

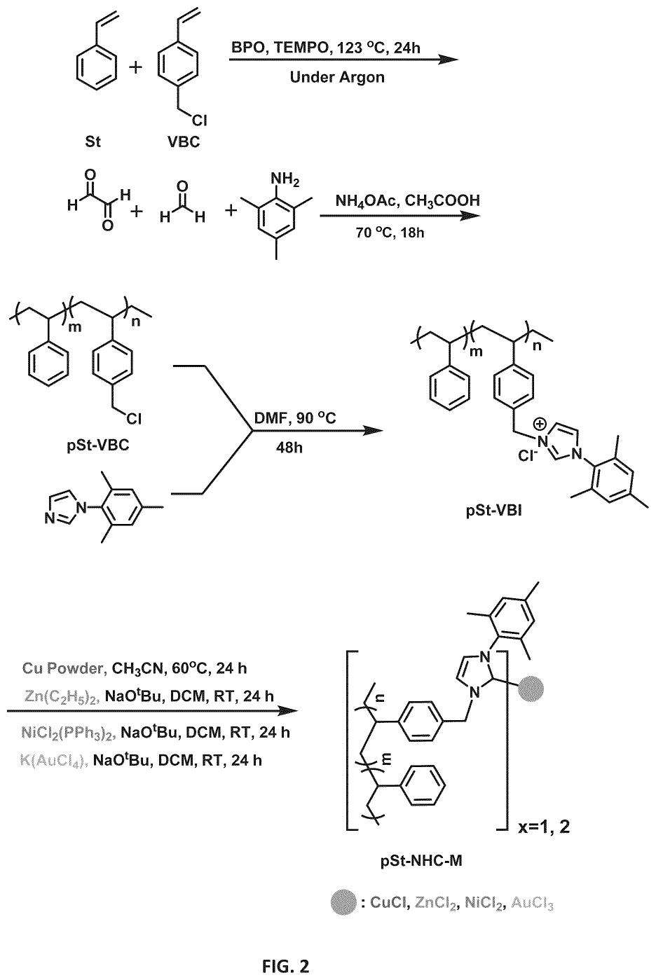

As further shown in the Examples section that follows, exemplary novel pSt-VBC based metallopolymers have been prepared via functionalization of chloromethyl groups by an imidazolium-based ligand, followed by the metalation of in situ generated NHCs using a base and mainly metals featuring low oxophilicity. See, FIG. 2.

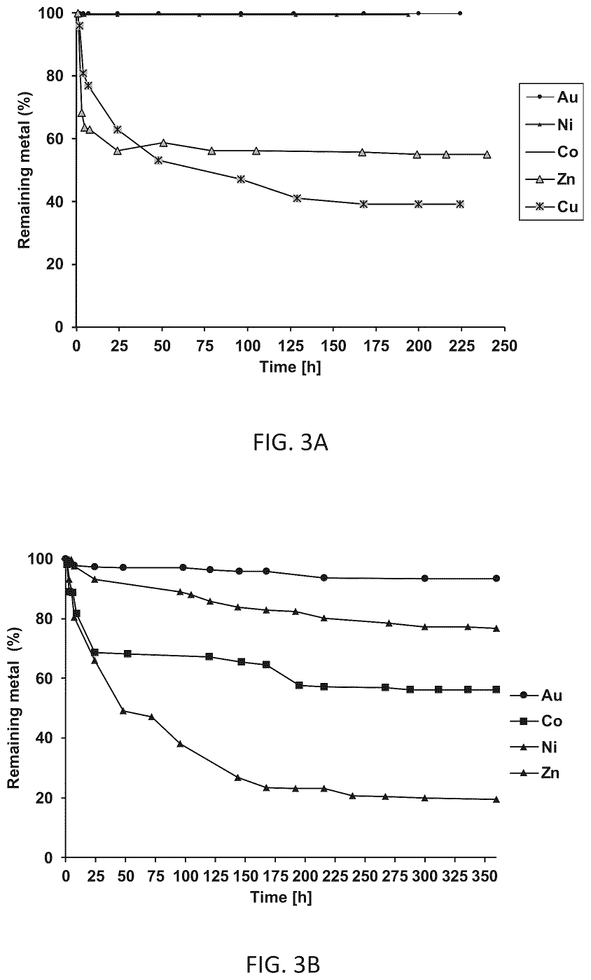

Among all the metallopolymers synthesized, pSt-NHC-Au, pSt-NHC-Ni and Co control metallopolymer showed no degradation (measured through metal leaching) in harsh alkaline aqueous conditions. See, FIG. 3A. In dry aggressive alkaline conditions, pSt-NHC-Ni and Co(control) metallopolymers exhibit about 20% metal leaching after about 300 hours, whereas the Au (least oxophilic metal) metallopolymer showed only 6% metal leaching in these conditions. See, FIG. 3B. The large difference in stability between the different metallopolymers suggests that the NHC ligand is stable under the harsh test conditions used and that metal-hydroxide bonding defines the metallopolymer stability. The exemplary pSt-NHC-Au and pSt-NHC-Ni exhibited excellent stability, with potential use to be applied as an anion exchange membrane for fuel cells and other electrochemical applications, as well as other applications in general, as described herein.

Without being bound by any particular theory, the results with this low valence ligand suggest that the metal center, and not only the organic part, is an important parameter in defining the metallopolymer lifetime. The results show that metallopolymers may be more stable than purely organic-based polymers used as ion exchange membranes (e.g., AEMs) and, in addition, open a wide door for further developments in the area, towards the achievement of highly stable AEMs for fuel cells and other electrochemical applications.

While reducing the present invention to practice, the present inventors have designed and successfully prepared and practiced novel, variable, metal-containing polymeric ion conductors and have demonstrated a successful performance of these ion conductors when used as an anion exchange membrane in an AEM fuel cell.

Embodiments of the present invention therefore relate to polymeric ion conductors, to ion exchange membranes, typically anion exchange membranes (AEMs), containing same, and to ion-exchange membrane fuel cells, typically anion exchange membrane fuel cells (AEMFC), and additional electrochemical devices containing these membranes. Embodiments of the present invention further relate to the use or incorporation of the polymeric ion conductors as described herein in other applications, including, for example, as disinfectants, or antibacterial agents, and in articles-of-manufacturing that can benefit from inclusion of such agents, such as, for example, clothes, food packages, packaging of pharmaceutical or cosmetic products, etc.; and/or as anticoagulants and/or antioxidants, that can be added to pharmaceutical compositions, for example.

These polymeric ionic conductors are composed of a polymeric backbone, a ligand, and a metal center, and are also referred to herein throughout as metallopolymers.

### Polymeric Ion Conductors

According to an aspect of some embodiments of the present invention there is provided a polymeric ion conductor which comprises a polymeric or co-polymeric backbone composed of a plurality of backbone units, a metal ligand attached to at least a portion of the backbone units, and a metal ion coordinated to the metal ligand.

Exemplary polymeric backbones include polymers which are stable in alkaline conditions. Such polymeric backbones typically include hydrocarbon-based backbone substituted and/or interrupted by one or more heteroatoms such as, for example, oxygen and/or sulfur, and/or by one or more groups such as tertiary amines, quaternary ammonium, ether, thioether, aryl, heteroaryl, heteroalicyclic, sulfoxide, sulfone and/or fluoride, and are typically devoid of halides other than fluoride, unsaturated groups featuring triple bonds (e.g., alkynes, nitriles), carboxylates, carbonyls, thiocarboxylates, thiocarbonyls and primary and secondary amines. Exemplary polymeric backbones include, but not limited to, polynorbornene, polystyrene, polyethylene, PTFE, polypropylene, polyethylene imide (PEI), polyimides (PI), poly(ethylene-tetrafluoroethylene) (ETFE), polyethers, epoxy polymers; and other polymers that are used for AEMs, such as poly(ethylene oxide) (PEO), poly(phenylene oxide) (PPO), polysulfones, poly(benzimidazole) (PBI) and poly(phenylene) (PP); including copolymers of two or more of any of the foregoing (thereby forming a co-polymeric backbone).

In exemplary embodiments, the polymeric backbones are of a polynorbornene, a polystyrene (PS) and/or a polyphenylene oxide (PPO), or a copolymer thereof.

High molecular weight random copolymers of styrene and 4-chlorovinyl styrene are easily prepared using, for example, nitroxide-mediated radical polymerization. Other syntheses include for example, controlled and uncontrolled radical polymerization, cationic polymerization, metal-catalyzed polymerization, photopolymerization. anionic polymerization, zwitterionic polymerization, etc. These polymers can be directly cast into thin membranes, as described hereinafter.

The polymers used for forming the metallopolymers are functionalized, in at least a portion of the backbone units composing the polymeric or co-polymeric backbone, by the ligands, through which they connect to the metal.

According to some of any of the embodiments described herein, the metal ligand is attached (e.g., by a single covalent or coordinative bond or by more than one covalent bond) to the backbone units as a pendant group and/or as a part of the backbone (linked to two backbone units).

The metal ligand according to any of the respective embodiments described herein can be attached to the backbone units either covalently or non-covalently, e.g., by electrostatic interactions, hydrophobic interactions, pi-stacking interactions, etc. Preferably, the metal ligand is attached to the backbone units covalently, either directly, or via a linking moiety.

According to some of any of the embodiments described herein, the metal ligand according to any of the respective embodiments described herein is covalently attached as a pendant group to a portion of the backbone units that compose the polymeric or co-polymeric backbone. The metal ligand can be attached directly to the backbone units or via a linking moiety. According to some of these embodiments, the polymer or co-polymer is composed of a plurality of backbone units, and at least a portion of the backbone units, e.g., 20%, 30%, 40%, 50%, 60%, 70%, 80%, 90% or even 100%, or any portion in a range of from 1% to 100% of the backbone units, has a metal ligand (according to any of the respective embodiments described herein) covalently attached thereto, either directly or indirectly via a linking moiety.

According to some of these embodiments, each metal ligand is attached to a backbone unit via one attachment point. Alternatively, each metal ligand is attached to two backbone units via two attachment points.

In exemplary embodiments, the backbone is a co-polymeric backbone in which a portion of the backbone units bear a functional moiety through which the metal ligand is covalently attached.

According to some of any of the embodiments described herein, the metal ligand according to any of the respective embodiments described herein forms a part of the polymeric backbone, that is, it is positioned between, and covalently linked to, two backbone units along the polymeric backbone. In such cases, a plurality of metal ligands is dispersed between the backbone units to form a co-polymeric backbone, and each metal ligand is attached to the two backbone units via two attachment points as described herein.

A linking moiety which links a metal ligand to a backbone unit (according to any of the respective embodiments described herein) may optionally be a substituted or non-substituted alkylene, optionally alkylene from 1 to 4 carbon atoms in length (e.g., substituted or non-substituted methylene or ethylene).

According to some of any of the embodiments described herein, the metal ligand is a monodentate ligand or a multidentate ligand.

Herein and in the art, the term “monodentate” refers to a ligand which binds to a metal via only one atom of the ligand; whereas “multidentate” refers to a ligand which binds to a metal via more than one atom of the ligand, for example, via two atoms (also referred to as “bidentate”) or via three atoms (also referred to as “tridentate”) thereof.

According to some of any of the embodiments described herein, the ligand comprises at least one N-heterocyclic carbene moiety. According to some of these embodiments, a monodentate ligand comprises one N-heterocyclic carbene moiety, e.g., as described herein, and a multidentate ligand (e.g., a bidentate or tridentate ligand) comprises one or more N-heterocyclic carbene moieties, e.g., as described herein.

According to some of any of the embodiments described herein, an N-heterocyclic carbene moiety is represented by general Formula I:

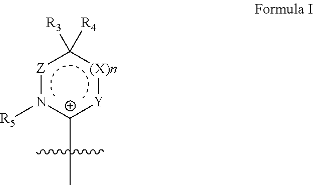

wherein:
the dashed line indicates an optional unsaturated bond;
X is —CR₆R₇—CR₈R₉— and/or —CR₁₀═CR₁₁—;
n is 0, 1 or 2, representing the number of X groups;
Y is —CR₁₂R₁₃—, —NR₁₄—, —S—, —O—, or absent;
Z is —CR₁R₂—, —NR₁₅—, —S—, —O—, or absent;

R₁, R₃, R₅ and R₁₅ are each independently hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and/or amino, or is absent in case the atom substituted thereby is linked to an adjacent atom via a double bond, or, alternatively, one of R₁, R₃, R₅ and R₁₅ is a linking moiety or a bond linking the heterocyclic moiety to a backbone unit of the polymeric backbone;

R₂, R₄, R₁₂, R₁₃ and R₁₄ are each independently hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and/or amino, or alternatively, one of R₂, R₄, R₁₂, R₁₃ and R₁₄ is a linking moiety or a bond linking the heterocyclic moiety to a backbone unit of the polymeric backbone;

R₆, R₇, R₈, R₉, R₁₀ and R₁₁ are each independently hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or, alternatively, one of R₆, R₇, R₈, R₉, R₁₀ and R₁₁ is a linking moiety or a bond linking the heterocyclic moiety to a backbone unit of the polymeric backbone;
and
the curved line represents an attachment (coordination) point to the metal ion,
wherein at least two of R₁-R₁₅, if present, may form a cyclic or heterocyclic ring, and
wherein at least one, and preferably one, of R₁-R₁₅ is the linking moiety or the bond linking the heterocyclic moiety to a backbone unit of the polymeric backbone; for example, an alkylene linking moiety (according to any of the respective embodiments described herein.

It is to be noted that a substituent (e.g., R₁-R₁₄) which forms a part of a cyclic or heterocyclic ring as described herein, typically is not the same substituent that is the linking moiety or the bond linking the heterocyclic moiety to a backbone unit of the polymeric backbone.

A “cyclic or heterocyclic ring” encompasses an alicyclic, aryl, heteroalicyclic and heteroaryl, as defined herein, each can independently be substituted or unsubstituted, as described herein.

According to some of any of the embodiments described herein for Formula I, R₅ is other than hydrogen.

According to some of any of the embodiments described herein for Formula I, Y is —NR₁₄. In some such embodiments, n is 0. In some of any of the aforementioned embodiments, R₁₄ is not hydrogen.

Without being bound by any particular theory, it is believed that when Y is —NR₁₄—, the nitrogen atom of Y considerably stabilizes the adjacent carbene. It is further believed that the presence of a substituent attached to an adjacent nitrogen stabilizes the carbene (e.g., wherein R₅ or R₁₄, and preferably each of R₅ and R₁₄, is not hydrogen).

According to some of any of the embodiments described herein for Formula I, the N-heterocyclic carbene moiety comprises at least one unsaturated bond indicated by the dashed line. In some such embodiments, an unsaturated bond exists between Z and the adjacent carbon atom attached to R₄ (and R₃ is absent).

In some of any of the respective embodiments, the N-heterocyclic carbene moiety comprises an aromatic ring, the ring including Y and Z, as well as the nitrogen atom attached to R₅ and X (if n is not 0). For example, aromaticity with six conjugated pi electrons may be obtained when an unsaturated bond exists between Z and the adjacent carbon atom attached to R₄, and either a) Y is —NR₁₄— and n is 0, or b) Y is absent, n is 1, and X is —CR ₁₀═CR₁₁—. Exemplary aromatic rings include imidazole (including imidazole fused to another ring, such as in benzimidazole) and triazole (e.g., wherein Y is —NR₁₄—, n is 0, and Z is —CR₂═ or —N═, respectively).

In some of any of the respective embodiments, the N-heterocyclic carbene moiety comprises a heteroalicyclic (i.e., non-aromatic) ring, optionally a saturated heteroalicyclic ring (i.e., wherein the dashed line indicates only saturated bonds). In some embodiments, Y is —NR₁₄—, and the ring comprises only two heteroatoms (e.g., Z is CR₁R₂). Exemplary saturated rings in which Y is —NR₁₄— include a 5-membered saturated ring (e.g., wherein Z is CR₁R₂ and n is 0) and a six-membered saturated ring (e.g., wherein Z is absent, n is 1, and X is —CR₆R₇—CR₈R₉—).

According to some of any of the embodiments described herein, an N-heterocyclic carbene moiety is represented by Formula Ia:

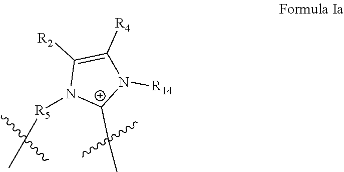

wherein R₅ is the linking moiety and the curved line next to it represents an attachment point to the backbone unit.

According to some of any of the embodiments described herein for Formula I or Ia, R₅ is an alkylene linking moiety (e.g., according to any of the respective embodiments described herein), which links the ligand to the polymeric backbone.

According to some of any of the embodiments described herein for Formula I or Ia, R₁₄ is an aryl. Mesityl (1,3,5-trimethylphenyl) is an exemplary aryl.

There are many types of N-heterocyclic carbenes (NHCs) which are usable in the context of the present embodiments and all are contemplated herein.

NHCs are neutral and bind extremely strongly to all metals.

Without being bound by any particular theory, it is believed that because NHC ligands are strong σ-donors and poor n-acceptors, they advantageously allow strong ligand-to-metal binding with very little tendency to dissociate.

NHCs can be prepared according to a typical synthesis, as described in scheme 1 below.

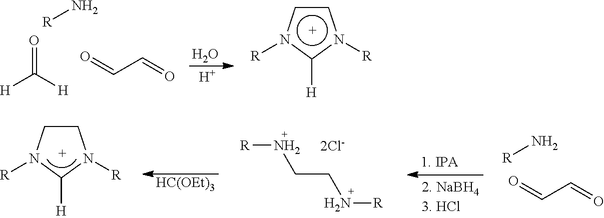

R can be, for example, alkyl, aryl, heteroaryl, alkaryl, cycloalkyl, heteroalicyclic, alkoxy, aryloxy, thioalkoxy, thioaryloxy, sulfone, sulfoxide, and like substituents.

Alternative ligands include, but are not limited to, multidentate ligand systems, which can provide strong coordination, and may kinetically inhibit metal leaching.

According to some of any of the embodiments described herein, the ligand is a multidentate ligand which comprises at least two nitrogen-containing heterocyclic (i.e., heteroalicyclic and/or heteroaryl) moieties, each being independently substituted or unsubstituted.

According to some of any of the embodiments described herein, the ligand comprises at least one nitrogen-containing heterocyclic (i.e., heteroalicyclic and/or heteroaryl) moiety, being independently substituted or unsubstituted. In some such embodiments, a nitrogen atom of the nitrogen-containing heterocyclic moiety is coordinated to the metal (e.g., as opposed to a carbon atom in an NHC described herein).

Pyridine (substituted or unsubstituted) is an exemplary nitrogen-containing heterocyclic. For example, the pyridine may be comprised by a monodentate ligand or by a multidentate ligand which comprises at least two pyridine moieties (e.g., two or three pyridine moieties, such as bipyridine (e.g., 2,2′-bipyridine) or ter-pyridine moieties), each being independently substituted or unsubstituted. A pyridine may optionally be attached to the backbone via the para position thereof (with respect to the nitrogen atom of the pyridine).

Additional examples of multidentate ligands include, without limitation, quaterpyridine (qtpy), which has been reported to form complexes with several metals, including some metals that exhibit low oxophilicity [see, for example, Dell'Amico et al. Inorg. Chem. Commun. 2005, 8 (8), 673-675; Guo et al. ChemSusChem 2017, 10 (20), 4009-4013; Gorczyliski et al. Chem. Rev. 2016, 116 (23), 14620-14674].

Mono-qtpy complexes are typically planar, meaning the counter anions sit at the axial positions, trans to each other. This factor is advantageous in metals with double charge, as the anions not only are more distant from the metal, but they also induce trans-influence at the second anion, perhaps improving conductivity.

Bis-qtpy complexes are also contemplated, expecting that the use of excess ligand in the polymer leads to more stably bound metals.

Adequate qtpys can be prepared as described, as a non-limiting example, in Scheme 2 below.

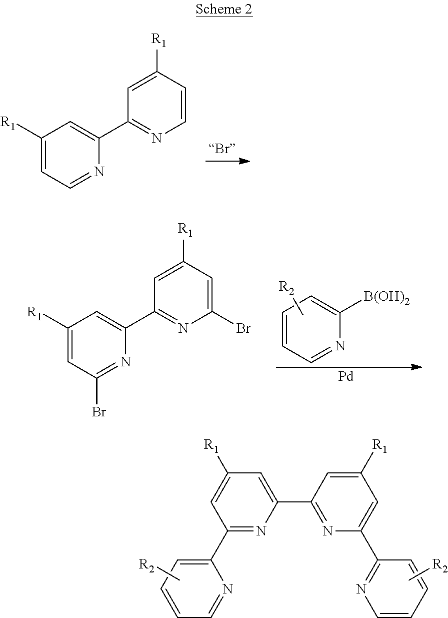

wherein each of the substituents denoted as R₁ and R₂ can be the same or different and each can independently be selected from alkyl, aryl, heteroaryl, alkaryl, cycloalkyl, heteroalicyclic, alkoxy, aryloxy, thioalkoxy, thioaryloxy, sulfoxide and like subsituents. Larger ligands such as quinquepyridine and sexipyridine are also contemplated.

In some of any of the embodiments described herein (e.g., embodiments relating to nitrogen-containing heterocyclic moiety), the polymeric ion conductor comprises no more than one type of metal ligand (e.g., no more than one type of nitrogen-containing heterocyclic moiety); that is, all of the ligands are substantially the same (although optionally attached to the backbone in different ways).

As exemplified in the Examples section herein, metallopolymers with one type of pyridine-based ligand were generally more stable than metallopolymers with multiple types of pyridine-based ligand (regardless of whether the ligands were monodentate or multidentate).

The metal cations in the metallopolymers as described herein are the component which makes the ion transportation possible.

A metal attached to a metal ligand (according to any of the respective embodiments described herein) may optionally be obtained by contacting a metal ligand (attached to a polymeric or co-polymeric backbone according to any of the respective embodiments described herein) with a metal, e.g., in a form of an ion or an organometallic complex, to thereby form a metal-metal ligand complex. Upon formation of the complex, the valence of the metal may remain the same or change (e.g., due to oxidation or reduction of the metal).

Examples of suitable metals include Ru, Ag, Hg, Cd, Pt, Cu, Co, Ni, Zn, Pd, Pb and Au.

According to some embodiments, the metal ions are of a metal that features low oxophilicity (e.g., a non-oxophilic metal), namely, a metal that does not bind strongly to oxygen, also in its ionized state. Such metals are more stable in the harsh conditions of AEMFCs and more ion-conductive.

Examples of metals of low oxophilicity include, without limitation, Co, Ni, Zn, Pd, Pb, Ag, Cd, Pt and Au. Au and Ni are exemplary metals, and Au is an example of a metal with particularly low oxophilicity.

According to some embodiments, the metal ions are of a metal that features oxophilicity lower than 0.4, preferably lower than 0.3, or lower than 0.2, when determined based on the metal-oxygen bond enthalpy as described in Kasper P. Kepp, Inorg. Chem., 2016, 55, 9461-9470.

According to some embodiments, the oxophilicity and ligand-metal binding energy are such that provide chemical stability to AEMs under extreme alkaline conditions. Ligand-metal binding energy can be optimized through electronic effects. For example, reducing steric hindrance in the ligand or increasing electron-density may provide for improved stability (reduced metal leaching). Increase in steric hindrance and electron density may provide for improved ion conductivity. Polar polymer backbones or side chains or ligands and/or increased water uptake can also be used for providing improved conductivity. Aromatic systems in the polymer backbone or as side chains may provide for improved mechanical stability.

According to some of any of the embodiments described herein, the polymeric ion conductor further comprises a counter ion; for example, an anion such as halide (e.g., chloride).

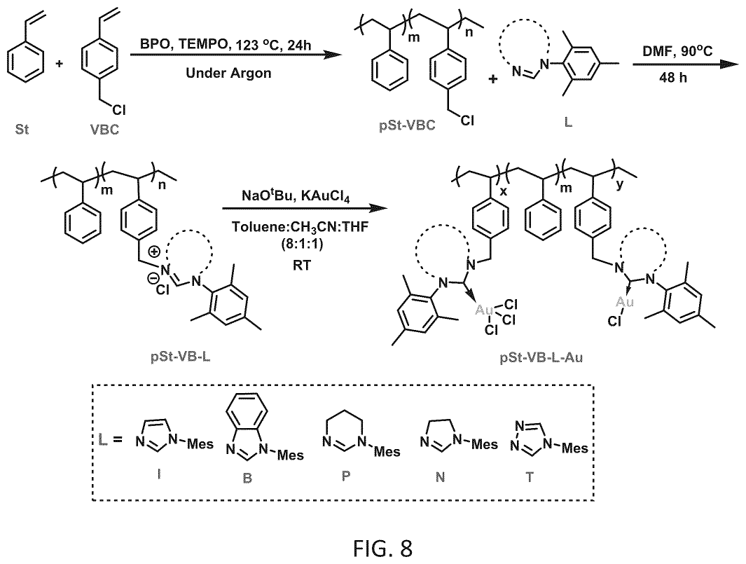

An exemplary method of preparing an exemplary polymeric ion conductor according to some of the present embodiments is shown in FIGS. 2 and 8. In this case, polystyrene was prepared, having, e.g., about 40% VBC moieties which are capable of binding ligands. The ligand was prepared and connected to the polymer as a side chain. Finally, different metals were bound to the polymer chain via the ligand.

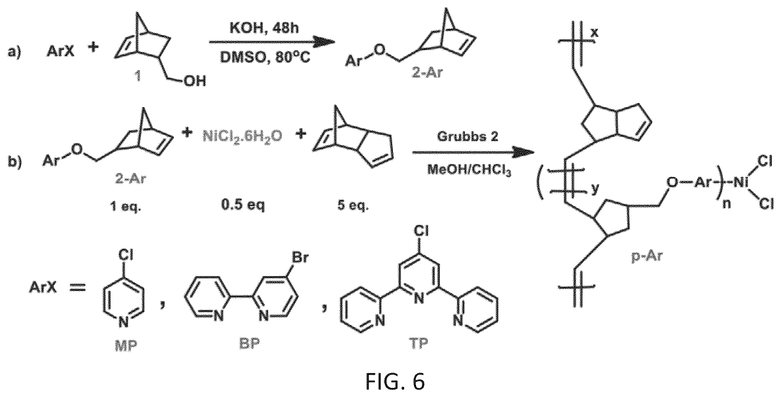

Another exemplary method of preparing an exemplary polymeric ion conductor according to some of the present embodiments is shown in FIG. 6. Norbornene attached to a metal ligand was polymerized (along with norbornene monomers which were not functionalized with a ligand) to form a ligand-functionalized polynorbornene.

Additional exemplary methods of preparing an exemplary polymeric ion conductor with various polymeric backbones (e.g., poly(phenylene oxide), poly(biphenyl-alkylene) or polyethylene) are presented in Example 7.

The polymeric ion conductors described herein represent a modular system in which the three components (metal, metal ligand and polymeric backbone units) can be independently tuned, so as to provide improved stability and increased the ion-conductivity.

As exemplified in the examples section below, ligands associated with relatively low metal leaching (e.g., stability under alkaline conditions) often exhibit relatively short metal-ligand bond lengths, for example, between a metal atom (e.g., gold or nickel) and a coordinating carbon atom of an NHC or a coordinating nitrogen atom in other heterocyclic ligands such as bipyridines, ter-pyridines, etc.

According to some of any of the embodiments described herein, the metal ligand in the metallopolymer is such that a length of the metal-ligand bond is at least 0.5%, or at least 1%, or at least 2%, or at least 3%, or at least 4%, or even at least 5%, for example, from 0.5 to 10%, or from 0.1 to 5%, less that an average bond length between the same metal (with the same valence and oxidation state) and respective ligands known in the art. For example, a length of a bond between AuCl₃ and an NHC ligand is less, as described herein, than a length of a bond between AuCl₃ and a carbon of a phenyl, as reported in the literature (for example, in CRC Handbook of Chemistry and Physics 97th Edition), or a carbon of an imidazole (as referred to in the Examples section that follows). In a further example, a length of a bond in a nickel complex with a pyridine-containing ligand as described herein between the nickel and the coordinating nitrogen(s) is less, as described herein, than an average length of a bond between nickel and the nitrogen in amine as reported in the literature (for example, in CRC Handbook of Chemistry and Physics 97th Edition), or a carbon of pyridine (as referred to in the Examples section that follows).

According to some of any of the embodiments described herein, whenever the metallopolymer is intended for use under conditions that require long-term chemical stability (e.g., as in AEMFCs), the ligand and the metal in the metallopolymer are selected as featuring a relatively short length of the ligand-metal bond.

According to some of any of the embodiments described herein, the metal-ligand bond length is lower than 2.2, or lower than 2.15, or lower than 2.10, or lower than 2.05, or even lower than 2 angstroms. In some such embodiments, the metal is gold, and the coordinated atom of the ligand is a heteroatom (i.e., not carbon).

According to some of any of the embodiments described herein, the metal-ligand bond length is lower than 2.05, or lower than 2.02, or lower than 2.01, or lower than 2, or even lower than 1.98, angstroms. In some such embodiments, the metal-ligand bond is gold-carbon bond (e.g., involving the carbon of an NHC, according to any of the respective embodiments described herein). In some alternative embodiments, the metal-ligand bond is a nickel-nitrogen bond (e.g., involving the nitrogen of one or more pyridine moiety, according to any of the respective embodiments described herein), which may optionally may have an even lower bond length, for example, lower than 1.96, angstroms, or even lower than 1.94 angstroms.

The bond length between the metal and metal ligand of the polymeric ion conductor may optionally be determined by determining (e.g., by a conventional technique such as x-ray crystallography) the bond length between the same metal and metal ligand when the metal ligand is not attached to a polymer.

### Anion Conducting Compositions

In some of any of the embodiments described herein, the metallopolymer has a cyclic moiety associated therewith.

According to an aspect of some embodiments of the present invention there is provided an anion conducting composition comprising a metallopolymer as described herein in any of the respective embodiments and any combination thereof and a cyclic moiety associated therewith.

By “associated with” it is meant that the cyclic moiety is bound to at least a portion of the metallopolymer via chemical or physical or mechanical interactions (e.g., mechanic interlocking as described herein).

The cyclic moiety can be covalently attached to the polymer, for example, as linked to polymeric backbone units while forming a part of the backbone, or be attached as one or more pendant groups or as one or more terminal groups, to the polymeric backbone of the polymeric ion conductors.

Without being bound by any particular theory, it is believed that a cyclic moiety may enhance the chemical stability of different functional groups in a polymer, without modulating its electronic properties, through a non-covalently bound steric shield.

The cyclic moiety can therefore alternatively be non-covalently attached to the ion conductor, for example, by means of mechanical interlocking as described in further detail herein.

According to some of any of the embodiments of this aspect of the present invention, the cyclic moiety is mechanically interlocked around a portion of the metallopolymer, as described herein. In some of these embodiments, the mechanical interlocking is by means of one or more end-capping moieties that form a part of the metallopolymer.

According to an aspect of some embodiments of the present invention there is provided a metallopolymer as described herein in any of the respective embodiments, in which the polymeric or copolymeric backbone has an end-capping moiety at a terminus thereof, and the polymeric backbone or a part thereof, is being threaded within the cyclic moiety. The end-capping moieties each has a volume larger than a volume of the cyclic moiety (the volume of the inner cavity of the cyclic moiety) to thereby have the cyclic moiety mechanically interlocked around the polymer. In other words, the polymer is threaded within the cyclic moiety, in the cavity thereof, and remains threaded due to the end capping moieties that prevent from the cyclic moiety to unthread.

According to some of any of the embodiments of these aspects of the present invention, the polymer is a linear polymer.

According to some of any of the embodiments of these aspects of the present invention, the polymeric ion conductors has a polymeric backbone composed of a plurality of backbone units, a portion or all of which can have pendant groups, and comprises end-capping moieties at each terminus of the polymeric backbone. In cases where the polymer is a linear polymer, it comprises two end-capping moieties, one at each terminus. In cases where the polymer is a branched or hyperbranched polymer, it may comprise an end-capping moiety at the terminus of each branch.

According to some embodiments of these aspects of the present invention there is provided a metallopolymer as described herein in any of the respective embodiments and any combination thereof, which features an end-capping moiety at each terminus thereof and a cyclic moiety, the polymer being threaded within one or more cyclic moiety/moieties, wherein each of the end-capping moieties has a volume larger than a volume of the (e.g., inner cavity of the) cyclic moiety to thereby have the cyclic moiety mechanically interlocked around the linear polymer.

According to some of these embodiments, the cyclic moiety/moieties is/are mechanically interlocked around the polymeric backbone, or, in other word, the polymeric backbone is threaded with the cyclic moiety.

According to some of these embodiments, the polymeric ion conductor is such that the metal ligand forms a part of the polymeric backbone.

According to some of any of the embodiments of this aspect of the present invention, the polymeric ion conductor is such that the metal ligand forms a part of the pendant groups of the polymer, as described herein in any of the respective embodiments. According to some of these embodiments, in at least a portion of the metal ligands, the metal ligand has an end-capping moiety having a volume larger than a volume of the (e.g., inner cavity of the) cyclic moiety, such that when the cyclic moiety is associated with the pendant group, it is mechanically interlocked around it, or, in other words, each such pendant group is threaded within the cyclic moiety.

According to some of any of the embodiments described herein, a mol ratio between the polymeric ion conductor (metallopolymers) and the cyclic moiety (e.g., crown ether) ranges from 10:1 to 1:10, or from 10:1 to 1:2, or from 10:1 to 1:1, or from 10:1 to 2:1, or from 10:1 to 5:1, including any intermediate values and subranges therebetween.

According to some of any of the embodiments of this aspect of the present invention and any combination thereof, the cyclic moiety is a heterocyclic moiety.

According to some of any of the embodiments described herein, the heterocyclic moiety comprises at least one electronegative heteroatom. Without being bound by any particular theory, it is assumed that electronegative atom is in electrostatic interaction with the positively charged portion (e.g., metal and/or metal ligand) of the polymeric ion conductor.

According to some of any of the embodiments described herein, the cyclic moiety comprises at least 12, or at least 16, or preferably at least 18, carbon atoms and may optionally further comprise one or more heteroatoms such as oxygen, nitrogen, sulfur, etc.

According to some of any of the embodiments described herein, the cyclic moiety is a crown ether, for example, a crown ether featuring a ring of at least 12 carbon atoms, or at least 16 carbon atoms or at least 18 carbon atoms, and 6, 8 or 10 oxygen atoms, respectively.

The crown ether can be substituted or unsubstituted. In some embodiments, the crown ether comprises aromatic groups.

The end-capping moiety or moieties can be selected in accordance with the size of the cyclic moiety, so as to feature a volume larger than the inner cavity of the cyclic moiety, to thereby provide the mechanical interlocking.

Exemplary end-capping moieties include, but are not limited to, aromatic or heteroaromatic moieties, featuring one, two or more rings, which can be fused to one another or be non-fused; and which can be substituted or unsubstituted; cycloalkyls or heteroalicyclic of at least 6 atoms, which can be substituted or unsubstituted; tertiary amine or quaternary ammonium groups, substituted by alkyls of at least 4 carbon atoms in length, and/or cycloalkyls of at least 6 carbon atoms, or aryls; each can independently be substituted or unsubstituted.

According to exemplary embodiments, the end-capping moiety is an aryl, for example, phenyl, which is substituted by two or more substituents. The substituents can be selected from alkyl, alkoxy, aryl, cycloalkyl, thioalkoxy, etc., as described herein.

As discussed and demonstrated herein, the association of the polymeric ion conductor and the cyclic moiety provides for improved stability of the polymeric ion conductor when subjected to an alkaline environment (e.g., of pH higher than 7, or higher than 8, or higher than 10, or higher). In some embodiments, the alkaline environment is a result of a presence of hydroxide ions which degrade the polymeric ion conductor.

According to some of any of the embodiments described herein, a stability of the polymeric ion conductor associated with a cyclic moiety when subjected to an alkaline environment as described herein is higher than a stability of the polymeric ion conductor in the absence of a cyclic moiety associated therewith as described herein.

According to some of any of the embodiments described herein, the cyclic moiety is for increasing a stability of the polymeric ion conductor when subjected to alkaline environment.

Further embodiments relating to an anion conducting composition are described in a PCT international patent application having Attorney's Docket 90027, which is co-filed with the instant application and claims priority from U.S. Provisional Patent Application No. 63/132,561, filed Dec. 31, 2020.

### Applications

Any of the ion conductors, and anion conducting compositions described herein feature a beneficial stability under alkaline environment and can therefore be beneficially utilized for forming a anion exchange membrane.

According to some of any of the embodiments described herein, less than 20%, or less than 10%, or less than 5%, of the metal ions dissociate from the polymeric ion conductor when it is exposed to extreme alkaline conditions.

The phrase “extreme alkaline conditions” encompasses conditions such as described in the Examples section that follows, for determining metal dissociation, using a dry KOH in crown-ether mixture dissolved at a concentration of 0.5 M in dry DMSO. The amount of metal that leached into the alkaline DMSO is analyzed to determine metal dissociation. Analysis can be made, for example, using ion-coupled plasma spectroscopy (ICP).

The chemical stability of the ionomeric materials (e.g., anion exchange membranes) made of the polymeric ion conductors of the present embodiments can be tested as described in the Examples section that follows, using a dry KOH in crown-ether mixture in the glove-box, by titration of metal potassium with water at 5° C. and dissolving it to 0.5 M in dry DMSO. The alkaline DMSO in which the membranes have been swelled is analyzed using ion-coupled plasma spectroscopy (ICP), to measure the amount of metal leaching.

In addition, direct measurements can be carried out on the ligands using confocal Raman spectroscopy, to provide additional spectroscopic information on the ligands. EDS-SEM can also be used to characterize metal content as a function of depth, to understand if the metal leaching is a process limited to the membrane surface.

According to some embodiments, the polymeric ion conductors described herein are used as ionomeric materials in electrochemical systems, for example, as part of an anion exchange membrane and/or as part of a catalyst layer.

According to some embodiments, the polymeric ion conductors described herein are used to make anion exchange membranes, which feature improved stability and at least sufficient conductivity, particularly when assembled to form a fuel cell, at varying operating currents.

According to an aspect of some embodiments of the present invention there is provided an ion exchange membrane (e.g., an anion exchange membrane) comprising the polymeric ion conductor as described herein in any of the respective embodiments and any combination thereof.

The membranes (according to any of the respective embodiments of any of the aspects described herein) can be cast following common procedures. The membranes can be cross-linked using aqueous solutions of diamines, such as hexamethylene diamine or by the ligands themselves, if they have more than one functional group. In any case, addition of the ligands with adequate amine substituents leads to bond formation by nucleophilic attack at, for example, the benzylic halide. The membranes are characterized using electron microscopy techniques, confocal Raman spectroscopy and solid-state NMR to confirm the chemical structure.

Following the functionalization of the polymeric or co-polymeric backbone (optionally in a form of a membrane) with the ligands, the metal cations are optionally chemically attached (e.g., absorbed in the membranes).

Alternatively or additionally, metal cations may be incorporated into a polymer by contact with monomeric backbone units functionalized with a metal ligand (e.g., a ligand comprising one or more pyridines, according to any of the respective embodiments described herein) prior to and/or concomitantly with polymerization of the monomeric backbone units.

Connection to NHCs can be done by applying an alkaline solution containing the relevant metal salt, following known procedures, for example, for NHC-metal binding. Metals can also be directly connected to e.g., pyridine ligands using a simple aqueous solution of the metal salt, for example, with non-coordinating anions such as BF4 or nitrate. Characterization with Raman spectroscopy may optionally be used to measure percentual incorporation. The counter anion is exchanged to chloride and ion-exchange capacity (IEC) measured by titration. The membranes can be characterized by additional methods relevant to their uses in electrochemical devices: water uptake, through and parallel conductivity, and mechanical properties.

According to an aspect of some embodiments of the present invention there is provided an electrochemical system comprising the polymeric ion conductor as described herein in any of the respective embodiments and any combination thereof, or the ion (e.g., anion) exchange membrane as described herein in any of the respective embodiments and any combination thereof.

According to some of these embodiments, the electrochemical system is a fuel cell, such as an anion exchange membrane fuel cell (AEMFC).

According to an aspect of some embodiments of the present invention there is provided an article-of-manufacturing comprising the polymeric ion conductor described herein in any of the respective embodiments and any combination thereof or the ion (e.g., anion) exchange membrane as described herein in any of the respective embodiments and any combination thereof or the electrochemical system as described herein in any of the respective embodiments.

Applications of the polymeric ion conductors according to the present embodiments include, but are not limited to, any electrochemical device where ionomeric materials and/or anion-exchange membranes are utilized (e.g., as solid electrolytes or as a catalyst layer for an electrode), including, but not limited to, electrolyzers, fuel cells (e.g., ion exchange membrane fuel cells such as AEMFCs), batteries (e.g., flow batteries, metal-air batteries, etc.), ultracapacitors, and ion and acid-base separators.

Additional applications include, without limitation, non-electrochemical articles such as disinfectants, antibacterial products, clothes, food packages, packaging of pharmaceutical or cosmetic products, anticoagulant-containing and/or antioxidant-containing pharmaceutical products.

Additional applications of the polymeric ion conductors according to the present embodiments are as described hereinabove.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

Herein throughout, the phrase “linking group” describes a group (a substituent) that is attached to another moiety in the compound via two or more atoms thereof. In order to differentiate a linking group from a substituent that is attached to another moiety in the compound via one atom thereof, the latter will be referred to herein and throughout as an “end group”.

Herein, the terms “amine” and “amino” each refer to either a —NR′R″ end group or a —N⁺R′R″R′″ end group, or to a —NR′— linking group or a —N⁺R′R″ linking group, wherein R′, R″ and R″′ are each hydrogen or a substituted or non-substituted alkyl, alkenyl, alkynyl, cycloalkyl, heteroalicyclic (linked to amine nitrogen via a ring carbon thereof), aryl, or heteroaryl (linked to amine nitrogen via a ring carbon thereof), as defined herein. Optionally, R′, R″ and R″′ are hydrogen or alkyl comprising 1 to 4 carbon atoms. Optionally, R′ and R″ (and R″′, if present) are hydrogen. When substituted, the carbon atom of an R′, R″ or R″′ hydrocarbon moiety which is bound to the nitrogen atom of the amine is not substituted by oxo (unless explicitly indicated otherwise), such that R′, R″ and R″′ are not (for example) carbonyl, C-carboxy or amide, as these groups are defined herein.

The amine group can therefore be a primary amine, where both R′ and R″ are hydrogen; a secondary amine, e.g., where R′ is hydrogen and R″ is alkyl, cycloalkyl or aryl; or a tertiary amine, e.g., where each of R′ and R″ is independently alkyl, cycloalkyl or aryl.

As used herein throughout, the term “alkyl” refers to any saturated aliphatic hydrocarbon including straight chain and branched chain groups. Preferably, the alkyl group has 1 to 20 carbon atoms. Whenever a numerical range; e.g., “1 to 20”, is stated herein, it implies that the group, in this case the hydrocarbon, may contain 1 carbon atom, 2 carbon atoms, 3 carbon atoms, etc., up to and including 20 carbon atoms. More preferably, the alkyl is a medium size alkyl having 1 to 10 carbon atoms. Most preferably, unless otherwise indicated, the alkyl is a lower alkyl having 1 to 4 carbon atoms. The alkyl group may be substituted or non-substituted. When substituted, the substituent group can be, for example, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein.

Herein, the term “alkenyl” describes an unsaturated aliphatic hydrocarbon comprise at least one carbon-carbon double bond, including straight chain and branched chain groups. Preferably, the alkenyl group has 2 to 20 carbon atoms. More preferably, the alkenyl is a medium size alkenyl having 2 to 10 carbon atoms. Most preferably, unless otherwise indicated, the alkenyl is a lower alkenyl having 2 to 4 carbon atoms. The alkenyl group may be substituted or non-substituted. Substituted alkenyl may have one or more substituents, whereby each substituent group can independently be, for example, alkynyl, cycloalkyl, alkynyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino.

Herein, the term “alkynyl” describes an unsaturated aliphatic hydrocarbon comprise at least one carbon-carbon triple bond, including straight chain and branched chain groups. Preferably, the alkynyl group has 2 to 20 carbon atoms. More preferably, the alkynyl is a medium size alkynyl having 2 to 10 carbon atoms. Most preferably, unless otherwise indicated, the alkynyl is a lower alkynyl having 2 to 4 carbon atoms. The alkynyl group may be substituted or non-substituted. Substituted alkynyl may have one or more substituents, whereby each substituent group can independently be, for example, cycloalkyl, alkenyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino.

The term “alkylene” describes a saturated or unsaturated aliphatic hydrocarbon linking group, as this term is defined herein, which differs from an alkyl group (when saturated) or an alkenyl or alkynyl group (when unsaturated), as defined herein, only in that alkylene is a linking group rather than an end group.

A “cycloalkyl” group refers to a saturated on unsaturated all-carbon monocyclic or fused ring (i.e., rings which share an adjacent pair of carbon atoms) group wherein one of more of the rings does not have a completely conjugated pi-electron system. Examples, without limitation, of cycloalkyl groups are cyclopropane, cyclobutane, cyclopentane, cyclopentene, cyclohexane, cyclohexadiene, cycloheptane, cycloheptatriene, and adamantane. A cycloalkyl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein. When a cycloalkyl group is unsaturated, it may comprise at least one carbon-carbon double bond and/or at least one carbon-carbon triple bond. The cycloalkyl group can be an end group, as this phrase is defined herein, wherein it is attached to a single adjacent atom, or a linking group, as this phrase is defined herein, connecting two or more moieties.

An “aryl” group refers to an all-carbon monocyclic or fused-ring polycyclic (i.e., rings which share adjacent pairs of carbon atoms) end groups having a completely conjugated pi-electron system. Examples, without limitation, of aryl groups are phenyl, naphthalenyl and anthracenyl. The aryl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein.

A “heteroaryl” group refers to a monocyclic or fused ring (i.e., rings which share an adjacent pair of atoms) end group having in the ring(s) one or more atoms, such as, for example, nitrogen, oxygen and sulfur and, in addition, having a completely conjugated pi-electron system. Examples, without limitation, of heteroaryl groups include pyrrole, furan, thiophene, imidazole, oxazole, thiazole, pyrazole, pyridine, pyrimidine, quinoline, isoquinoline and purine. The heteroaryl group may be substituted or non-substituted. When substituted, the substituent group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein.

The term “arylene” describes a monocyclic or fused-ring polycyclic linking group, as this term is defined herein, and encompasses linking groups which differ from an aryl or heteroaryl group, as these groups are defined herein, only in that arylene is a linking group rather than an end group.

A “heteroalicyclic” group refers to a monocyclic or fused ring group having in the ring(s) one or more atoms such as nitrogen, oxygen and sulfur. The rings may also have one or more double bonds. However, the rings do not have a completely conjugated pi-electron system. The heteroalicyclic may be substituted or non-substituted. When substituted, the substituted group can be, for example, alkyl, alkenyl, alkynyl, cycloalkyl, aryl, heteroaryl, heteroalicyclic, halo, hydroxy, alkoxy, aryloxy, thiohydroxy, thioalkoxy, thioaryloxy, sulfinyl, sulfonyl, sulfonate, sulfate, cyano, nitro, azide, phosphonyl, phosphinyl, oxo, imine, oxime, hydrazone, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, as these terms are defined herein. Representative examples are piperidine, piperazine, tetrahydrofuran, tetrahydropyrane, morpholine and the like. The heteroalicyclic group can be an end group, as this phrase is defined herein, wherein it is attached to a single adjacent atom, or a linking group, as this phrase is defined herein, connecting two or more moieties.

An “azide” group refers to a —N═N⁺═N⁻ end group.

An “alkoxy” group refers to any of an —O-alkyl, —O-alkenyl, —O-alkynyl, —O-cycloalkyl, and —O-heteroalicyclic end group, as defined herein, or to any of an —O-alkylene, —O-cycloalkyl- and —O-heteroalicyclic-linking group, as defined herein.

An “aryloxy” group refers to both an —O-aryl and an —O-heteroaryl group, as defined herein, or to an —O-arylene.

A “hydroxy” group refers to a —OH group.

A “thiohydroxy” or “thiol” group refers to a —SH group.

A “thioalkoxy” group refers to any of an —S-alkyl, —S-alkenyl, —S-alkynyl, —S-cycloalkyl, and —S-heteroalicyclic end group, as defined herein, or to any of an —S-alkylene-, —S-cycloalkyl- and —S-heteroalicyclic-linking group, as defined herein.

A “thioaryloxy” group refers to both an —S-aryl and an —S-heteroaryl group, as defined herein, or to an —S-arylene.

A “carbonyl” or “acyl” group refers to a —C(═O)—R′ end group, where R′ is defined as hereinabove, or to a —C(═O)— linking group.

A “thiocarbonyl” group refers to a —C(═S)—R′ end group, where R′ is as defined herein, or to a —C(═S)— linking group.

A “carboxy”, “carboxyl”, “carboxylic” or “carboxylate” group refers to both “C-carboxy” and “O-carboxy” end groups, as defined herein, as well as to a carboxy linking group, as defined herein.

A “C-carboxy” group refers to a —C(═O)—O—R′ group, where R′ is as defined herein.

An “O-carboxy” group refers to an R′C(═O)—O— group, where R′ is as defined herein.

A “carboxy linking group” refers to a —C(═O)—O— linking group.

An “oxo” group refers to a ═O end group.

An “imine” group refers to a ═N—R′ end group, where R′ is as defined herein, or to an ═N— linking group.

An “oxime” group refers to a ═N—OH end group.

A “hydrazone” group refers to a =N-NR′R″ end group, where each of R′ and R″ is as defined herein, or to a ═N—NR′— linking group where R′ is as defined herein.

A “halo” group refers to fluorine, chlorine, bromine or iodine.

A “sulfinyl” of “sulfoxide” group refers to an —S(═O)—R′ end group, where R′ is as defined herein, or to an —S(═O)— linking group.

A “sulfonyl” or “sulfone” group refers to an —S(═O)₂—R′ end group, where R′ is as defined herein, or to an —S(═O)₂— linking group.

A “sulfonate” group refers to an —S(═O)₂—O—R′ end group, where R′ is as defined herein, or to an —S(═O)₂—O— linking group.

A “sulfate” group refers to an —O—S(═O)₂—O—R′ end group, where R′ is as defined as herein, or to an —O—S(═O)₂—O— linking group.

A “sulfonamide” or “sulfonamido” group encompasses both S-sulfonamido and N-sulfonamido end groups, as defined herein, as well as a sulfonamide linking group, as defined herein.

An “S-sulfonamido” group refers to a —S(═O)₂—NR′R″ end group, with each of R′ and R″ as defined herein.

An “N-sulfonamido” group refers to an R′S(═O)₂—NR″— end group, where each of R′ and R″ is as defined herein.

A “sulfonamide linking group” refers to a —S(═O)₂—NR′— linking group, where R′ is as defined herein.

A “carbamyl” group encompasses both O-carbamyl and N-carbamyl end groups, as defined herein, as well as a carbamyl linking group, as defined herein.

An “O-carbamyl” group refers to an —OC(═O)—NR′R″ end group, where each of R′ and R″ is as defined herein.

An “N-carbamyl” group refers to an R′OC(═O)—NR″— end group, where each of R′ and R″ is as defined herein.

A “carbamyl linking group” refers to a —OC(═O)—NR′— linking group, where R′ is as defined herein.

A “thiocarbamyl” group encompasses O-thiocarbamyl, S-thiocarbamyl and N-thiocarbamyl end groups, as defined herein, as well as a thiocarbamyl linking group, as defined herein.

An “O-thiocarbamyl” group refers to an —OC(═S)—NR′R″ end group, where each of R′ and R″ is as defined herein.

An “N-thiocarbamyl” group refers to an R′OC(═S)NR″— end group, where each of R′ and R″ is as defined herein.

An “S-thiocarbamyl” group refers to an —SC(═O)—NR′R″ end group, where each of R′ and R″ is as defined herein.

A “thiocarbamyl linking group” refers to a —OC(═S)—NR′— or —SC(═O)—NR′— linking group, where R′ is as defined herein.

An “amide” or “amido” group encompasses C-amido and N-amido end groups, as defined herein, as well as an amide linking group, as defined herein.

A “C-amido” group refers to a —C(═O)—NR′R″ end group, where each of R′ and R″ is as defined herein.

An “N-amido” group refers to an R′C(═O)—NR″— end group, where each of R′ and R″ is as defined herein.

An “amide linking group” refers to a —C(═O)—NR′— linking group, where R′ is as defined herein.

A “urea group” refers to an —N(R′)—C(═O)—NR″R′″ end group, where each of R′, R″ and R″ is as defined herein, or an —N(R′)—C(═O)—NR″— linking group, where each of R′ and R″ is as defined herein.

A “thiourea group” refers to an —N(R′)—C(═S)—NR″R″′ end group, where each of R′, R″ and R″ is as defined herein, or an —N(R′)—C(═S)—mNR″— linking group, where each of R′ and R″ is as defined herein.

A “nitro” group refers to an —NO₂ group.

A “cyano” group refers to a —C≡N group.

The term “phosphonyl” or “phosphonate” describes a —P(═O)(OR′)(OR″) group, with R′ and R″ as defined herein, or a —P(═O)(OR′)—O— linking group, with R′ as defined herein.

The term “phosphate” describes an —O—P(═O)(OR′)(OR″) end group, with each of R′ and R″ as defined herein, or an —O—P(═O)(OR′)—O— linking group, with R′ as defined herein.

The term “phosphinyl” describes a —PR′R″ end group, with each of R′ and R″ as defined herein, or a —PR′— linking group, with R′ as defined herein.

The term “hydrazine” describes a —NR′—NR″R′″ end group, where R′, R″, and R″' are as defined herein, or to a —NR′—NR″— linking group, where R′ and R″ are as defined herein.

As used herein, the term “hydrazide” describes a —C(═O)—NR′—NR″R″′ end group, where R′, R″ and R′″ are as defined herein, or to a —C(═O)—NR′—NR″— linking group, where R′ and R″ are as defined herein.

As used herein, the term “thiohydrazide” describes a —C(═S)—NR′—NR″R″′ end group, where R′, R″ and R′″ are as defined herein, or to a —C(═S)—NR′—NR″— linking group, where R′ and R″ are as defined herein.

A “guanidinyl” group refers to an —RaNC(═NRd)—NRbRc end group, where each of Ra, Rb, Rc and Rd can be as defined herein for R′ and R″, or to an —R′NC(═NR″)—NR′″— linking group, where R′, R″ and R′″ are as defined herein.

A “guanyl” or “guanine” group refers to an R″′R″NC(═NR′)— end group, where R′, R″ and R′″ are as defined herein, or to a —R″NC(═NR′)— linking group, where R′ and R″ are as defined herein.

The compounds and structures described herein encompass any stereoisomer, including enantiomers and diastereomers, of the compounds described herein, unless a particular stereoisomer is specifically indicated.

As used herein, the term “enantiomer” refers to a stereoisomer of a compound that is superposable with respect to its counterpart only by a complete inversion/reflection (mirror image) of each other. Enantiomers are said to have “handedness” since they refer to each other like the right and left hand. Enantiomers have identical chemical and physical properties except when present in an environment which by itself has handedness, such as all living systems. In the context of the present embodiments, a compound may exhibit one or more chiral centers, each of which exhibiting an (R) or an (S) configuration and any combination, and compounds according to some embodiments of the present invention, can have any their chiral centers exhibit an (R) or an (S) configuration.

The term “diastereomers”, as used herein, refers to stereoisomers that are not enantiomers to one another. Diastereomerism occurs when two or more stereoisomers of a compound have different configurations at one or more, but not all of the equivalent (related) stereocenters and are not mirror images of each other. When two diastereoisomers differ from each other at only one stereocenter they are epimers. Each stereo-center (chiral center) gives rise to two different configurations and thus to two different stereoisomers. In the context of the present invention, embodiments of the present invention encompass compounds with multiple chiral centers that occur in any combination of stereo-configuration, namely any diastereomer.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Preparation of Metallopolymers

An exemplary organic polymer backbone with a general N-heterocyclic carbene (NHC) ligand, capable of binding different metals, has been designed and successfully practiced. NHC based ligands were conceived as being strong σ-donors but poor π-acceptor ligands, which bind strongly to the metal center with little tendency to dissociate from it.

A styrene polymeric backbone was selected as an exemplary polymeric backbone capable of connecting an NHC ligand. Polystyrene has been reported as exhibiting excellent mechanical properties, chemical stability and water uptake (which reduces hydroxide reactivity by better hydration). The synthetic strategy is depicted in FIG. 2 and involves a three-step approach, as follows.

Poly(styrene-co-4-vinyl benzyl chloride) (pSt-VBC) was prepared by nitroxide-mediated radical polymerization (NMP) using 2,2,6,6-tetramethylpiperidin-1-yl)oxyl (TEMPO) as the nitroxide mediator at 123° C., according to Veregin et al. (1995) Macromolecules 28, 4391-4398]. The obtained polymer presented 94 kDa (from triple-detector GPC) and contains 20% VBC and 80% styrene, as calculated from ¹H NMR [Jonikaite-Svegzdiene et al. (2017) Polym. Chem. 8, 5621-563].

1-Mesitylimidazole was prepared following a literature procedure [Zhao, Y., and Gilbertson, S. R. (2014). Org. Lett. 16, 1033-1035] and reacted with the pSt-VBC until no benzyl chloride peaks were observed by NMR.

Finally, the metallopolymers were obtained by the metallation of in-situ generated NHCs in the presence of a base, using a series of non-oxophilic metals [Kepp, K. P. P. (2016) Inorg. Chem. 55, 9461-9470] including copper, zinc, nickel and gold.

The synthesis of the copper polymer with complexes of the type [(NHC)CuX] (X=halide) took place under air without removal of moisture and oxygen, using an excess of copper powder which could be easily removed via simple filtration after reaction completion [Liu et al. (2015) Dalt. Trans. 44, 1836-1844].

The other metallopolymers were prepared using soluble metal sources: NiCl₂(PPh₃)₂, KAuCl₄ and Zn(C₂H₅)₂, following procedures previously used to make the simple organometallic complexes [Matsubara et al. (2006) Organometallics 25, 3422-3427; Dinda, et al. (2013) New J. Chem. 37, 431-438; Naktode et al. (2014) J. Coord. Chem. 67, 236-248].

pSt-NHC-Cu was soluble, indicating that a single NHC per copper was obtained. All other metallopolymers were insoluble in all solvents, suggesting that part of the metal atoms are binding to two NHC ligands.

In addition to the new metallopolymers prepared as described above, an additional metallopolymer was synthesized for comparison; a polycyclooctene polymer with cobaltocenium side chains, which was reported to exhibit promising performance as an AEM [Zhu et al. (2018) supra]. These polymers have been tested in alkaline water and exhibited long-term durability, good mechanical toughness and flexibility, good chemical stability as well as good ion conductivity. The metal center in these metallopolymers is connected to the polymer backbone through an ionic η⁵ connection, which is significantly stronger than the NHC.

Following is a detailed description of the syntheses of the above-described metallopolymers.

All materials, unless otherwise stated, were purchased from commercial sources and utilized as-received, without any further purification. Monomers and THF were purified by filtration through basic alumina column. 1-Mesityl imidazole was prepared according to Zhao et al., 2014, supra. The cobalt-based control polymer was prepared according to Zhu et al. (2018).

### Preparation of Styrene-Vinyl Benzyl Chloride Copolymer (pSt-VBC)

A copolymer with 1:0.25 styrene to VBC molar ratio was synthesized using controlled free radical polymerization. Benzoyl peroxide (BPO) (6.5 mg, 26.41 μmol), 2,2,6,6-tetramethylpiperidin-1-yloxyl (TEMPO) (12.6 mg, 80.74 μmol), VBC (1 mL, 7.1 mmol) and styrene (3.25 mL, 28.4 mmol) were added to a Schlenk flask and sealed with a rubber septum. After three freeze-thaw-pump cycles, the flask was immersed in an oil bath at 123° C. The polymerization was conducted under argon atmosphere with magnetic stirring until the solution became viscous and the magnetic stirrer stopped moving. Then, the reaction product was dissolved in dichloromethane and the polymer precipitated in methanol, providing the pure product as a white powder. Yield 2.56 grams, 65%.

¹H NMR (CDCl₃): δ=6.30-7.45; (5H, Ph—H), 4.4-4.8; (2H, —CH₂Cl), 1.2-2.2; (3H, —CHCH₂—) ppm.

GPC (THF): 94 KDa.

### Preparation of Styrene-Vinyl Benzyl Chloride Copolymer Functionalized by 1-mesityl Imidazole (pSt-VBI)

In a 50 mL round bottom flask, pSt-VBC (0.72 gram, 1.60 mmol of chlorine-containing monomeric units) was dissolved in DMF (10 mL). 1-Mesityl imidazole (0.4334 gram, 2.4 mmol) was then added and the reaction mixture was stirred at 90° C. for 48 hours. After the completion of the reaction (determined by ¹H NMR), the product was precipitated in diethyl ether. The precipitate was re-dissolved in a minimal amount of dichloromethane and re-precipitated in hexane. The pure product was obtained as a light brown solid. Yield: 1.50 gram, 85%.

¹H NMR (CDCl₃): δ=10.6; (—NCHN—), 6.30-7.45; (Ph—H and —CH═CH), 5.65-5.87; (—CH₂N⁺—), 1.2-2.2; (—CHCH₂—) ppm.

### Complexation of pSt-VBI with Cu (pSt-NHC-Cu)

In a 50 mL round bottom flask, pSt-VBI (100 mg, 0.15 mmol of imidazolium functionalized monomeric units) was dissolved in acetonitrile (10 mL) and Cu powder (47.2 mg, 0.76 mmol) was added. The reaction mixture was stirred at 60° C. for 24 hours. The reaction mixture was filtered and the filtrate concentrated under vacuum. The solid obtained was dissolved in dichloromethane and precipitated in methanol. Yield: 150 mg, 90%.

¹H NMR (CDCl₃): δ=6.30-7.45; (Ph—H), 6.05-6.25; (—CH═CH—), 4.50-4.75; (—CH₂N—), 1.2-2.2; (—CHCH₂—) ppm.

### Complexation of pSt-VBI with Zn (pSt-NHC-Zn)

In a 20 mL vial, pSt-VBI (100 mg, 0.15 mmol of imidazolium functionalized monomeric units) was dissolved in acetonitrile (10 mL) in the glove box, followed by addition of diethylzinc (15 wt. % solution in toluene, 38.2 μL, 0.76 μmol). The reaction mixture was stirred at room temperature for 24 hours, before evaporating the solvent to provide a yellow solid, which was further washed with hexane. The polymer is obtained as a pale white, insoluble solid. Yield: 141 mg, 92%.

### Complexation of pSt-VBI with Ni (pSt-NHC-Ni)

In a 50 mL round bottom flask, pSt-VBI (100 mg, 0.15 mmol of imidazolium functionalized monomeric units) was dissolved in dichloromethane (10 mL). Sodium tert-butoxide (17.5 mg, 0.18 mmol) was added and the reaction was stirred at room temperature for 3 hours. NiCl₂(PPh₃)₂ (291 mg, 0.45 mmol) was added and the reaction stirred at 40° C. for 5 hours. The reaction mixture was concentrated under reduced pressure, and the solid was filtered and washed with acetone and ether. The polymer is obtained as a green, insoluble solid. Yield: 97 mg, 89%.

### Complexation of pSt-VBI with Au (pSt-NHC-Au) During Membrane Casting

In a glove-box, in a 10 mL vial, pSt-VBI (100 mg, 0.15 mmol of imidazolium functionalized monomeric units) was dissolved in dry toluene (2 mL). Sodium tert-butoxide (17.5 mg, 0.18 mmol) was added and the reaction was stirred at room temperature for 10 minutes. KAuCl₄ (114 mg, 0.30 mmol) dissolved in minimal amount of acetonitrile was added. The reaction mixture was stirred for additional 2 minutes and then casted in 4×2 cm polytetrafluoroethylene molds. After complete evaporation of the solvent, membrane was removed and washed with deionized (DI) water several times to ensure complete removal of byproducts.

In order to quantify the amount of metal per metallopolymer, samples from each metallopolymer were dried under high vacuum overnight, before introducing them into thermogravimetric analysis (TGA), where the samples were burnt at 1500° C. under an oxygen atmosphere. After mass stabilization, all the remaining mass belongs to the metal oxide (MO) formed from the metal (M) in the polymer. In the case of zinc, when heated with carbon at temperature above 950° C., it is converted into zinc vapor (ZnO+C→Zn_{(Vapor)}+CO), and in order to measure its precise amount, inductively coupled plasma spectroscopy (ICP) was used.

These values were determined in order to calculate the amount of metal leached during the stability tests, and to evaluate the ion exchange capacity (IEC) of the metallopolymers (which support the anion-exchange function of the AEM). The IEC in a metallopolymer is a function of the metal concentration, and was directly calculated from the TGA/ICP metal wt. %, as well as from the chemical composition calculated from ¹H-NMR. IEC can also be measured directly by exchanging the membrane counter anions to chloride and carrying out an AgNO₃ titration.

Table 1 below presents the data obtained for quantification of ion-conductive elements in the metallopolymer, determined by TGA analyses (a), as shown in the below equation; by ICP (b), from molar composition by ¹H-NMR (c), and/or by titrating chloride with AgNO₃ (d).

$$\% of metal = \frac{\begin{matrix}Mass of MO * \\ Molecular weight of M * \\ 100\end{matrix}}{\begin{matrix}Initial mass of Metallopolymer * \\ Molecular weight of MO\end{matrix}}$$

TABLE 1

| | | Calculated | | |
|---|---|---|---|---|
| | | IEC | Theoretical | Measured |
| | | from % | IEC | IEC |
| | | metal | (mmol/ | (mmol/ |
| | Wt % of | (mmol/ | gram) | gram) |
| Metal | metal | gram) | (c) | (d) |
| Cu | 12.22 (a) | 1.92 | 1.40 | 0.16 |
| Zn | 6.36 (b) | 1.94 | 1.89 | 0.95 |
| Ni | 10.97 (a) | 3.72 | 1.90 | 0.72 |
| Au | 18.38 (a) | 2.79 | 3.98 | 3.51 |
| Cobalt-control | 13.37 (a) | 2.26 | 1.66 | 1.23 |

Of note, pSt-NHC-Au showed a good ion exchange capacity (IEC) of 3.51 mmol/gram (average of three titrations). The calculated theoretical value is 3.98 mmol/gram, indicating that the Au(III) is stable in the test conditions.

Water uptake (WU) for the exemplary metallopolymers was also measured using a VTI SA⁺ instrument (TA Instruments, USA). The relative humidity (RH) was determined with a two-stage chilled-mirror dew-point analyzer and adjusted by mixing dry and humidified nitrogen gas. Each sample was initially dried in situ for up to 150 minutes at 60° C. with RH of about 0%. The temperature was then decreased to 40° C., and RH step-increase to 95% was performed. The RH was maintained until the sample weight reached equilibrium (<0.001 wt % change in 5 minutes). WU was calculated from the “wet” weight [W(wet)] at each equilibrium and the “dry” weight [W(dry)] at the end of the initial drying step, according to the following equation:

$$WU = \frac{W ( wet ) - W ( dry )}{W ( dry )} \times 100$$

The WU kinetics was measured by following the mass change of the AEM as a function of time, upon the abovementioned increase in RH. The characteristic time constant, T, was calculated by fitting the experimental data with the following equation:

$$\frac{{W}_{t} - {W}_{0}}{{W}_{∞} - {W}_{0}} = \frac{{M}_{t}}{{M}_{∞}} ≅ 1 - exp ( - \frac{t}{τ} )$$

Table 2 below summarizes WU of the four exemplary metallopolymers in their chloride form at 25° C. and 40° C. at 95% RH. These data show that the exemplary nickel-based metallopolymer had the highest WU amongst the four exemplary metallopolymers, and that the exemplary gold-based metallopolymer also exhibits a relatively high WU, whereas the exemplary copper-based metallopolymer has the lowest WU.

These results indicate that polystyrene-NHC-nickel metallopolymer and polystyrene-NHC-gold metallopolymer would be particularly effective AEMs in fuel cells, as the higher WU helps in increasing the water content in the membrane, which both helps with ionic conductivity and reduces hydroxide reactivity [Dekel et al. (2017) Chem. Mater., 29, 4425-4431].

TABLE 2

| | Water uptake | | Water uptake characteristic time | |
|---|---|---|---|---|
| | (%) | | (τ, minutes) | |
| Polymer | 25° C. | 40° C. | 25° C. | 40° C. |
| pSt-NHC-Cu | 0.43 | 0.69 | not calculated | not calculated |
| pSt-NHC-Zn | 2.69 | 2.98 | 10.99 | 6.35 |
| pSt-NHC-Ni | 355.40 | 467.20 | 308.60 | 168.40 |
| pSt-NHC-Au | 174.10 | 227.30 | 301.20 | 169.20 |
| Co-control | 1.75 | 1.83 | 4.34 | 1.86 |

### Example 2

### Chemical Stability

The chemical stability of the metallopolymers was determined under harsh alkaline conditions. Given that metal cations cannot undergo chemical decomposition, metallopolymer degradation in the presence of strong bases and nucleophiles can only occur by metal-ligand dissociation, either by changing the ligand sphere of the metal or by ligand degradation [DeVos et al. (2014) ChemElectroChem 1, 1258-1270]. Therefore, in order to quantify the stability of the metallopolymer structure, metal leaching to the solution was measured using ICP as a function of exposure time.

Among the many different alkaline tests, two protocols that are considered amongst the harshest used for quaternary ammonium (QA) testing were selected. The first is a 3M NaOH in 7:3 methanol-H₂O solution at 80° C., as described, for example, in Fan et al. (2019) Nat. Commun. 10, 230]. This protocol uses a protic solvent, producing organic nucleophiles in addition to the base. These alkaline conditions were found to be very aggressive, capable of degrading the most stable QA cations in a very short period of time [Diesendruck and Dekel, (2018) Curr. Opin. Electrochem. 9, 173-178; Dekel et al. (2017) Chem. Mater. 29, 4425-4431]. Therefore, this is a very good ‘fast’ stability screening for determining the potential stability of the designed metallopolymers.

In this test, the metallopolymer (10 mg) is added to the NaOH solution (100 mL) at 80° C. At different time intervals, an aliquot of the clear liquid (0.1 mL) is taken, diluted in Milli-Q water (9.9 mL) and analyzed by ICP, which is calibrated to the intended metal. The quantity of metal leached is calculated and compared to the original amount of metal in the metallopolymer. Each metallopolymer was tested 3 times for statistical analysis.

The obtained data is presented in FIGS. 3A-3B. As seen in FIG. 3A, the pSt-NHC-Cu and pST-NHC-Zn metallopolymers showed, respectively, 60 and 45% metal leaching after 200 hours in the test conditions. These results suggest that these metallopolymers are relatively stable, as the stability is comparable to the most widely studied trimethyl benzylammmonium (TMBA) cations, which showed 50% decomposition after 180 hours under similar conditions [Fan et al. (2019) supra]. pSt-NHC-Au, pSt-NHC-Ni, and the cobalt-based control did not leach any detectable metal quantities in the same conditions for the duration of the test (240 hours).

The leading metallopolymers were taken to the second, harsher stability test, using hydroxide in completely dry, aprotic conditions. This protocol was shown to better represent the aggressive conditions in an operating AEMFC [Dekel et al. (2017) Chem. Mater. 29, 4425-4431].

An extremely dry KOH solution is prepared in the glovebox by titration of metal potassium dissolved in molten 18-crown-6 with water at 50° C., followed by dissolution in dry DMSO (0.5 M KOH was obtained). When exposed to these test conditions, the pSt-NHC-Zn showed about 50% decomposition in about 70 hours, and was thus shown to be comparable to TMBA [Dekel et al., 2017, supra]. The cobalt metallopolymer control (cross-linked with ca. 0.5 mol % dicyclopentadiene), in which the metal is connected through an ionic η⁵ ligand, showed rapid degradation, reaching about 31% in about 24 hours, and thereafter became relatively stable, showing a slow but continuous metal leaching over time.

pSt-NHC-Ni and pSt-NHC-Au demonstrate significantly superior stability. pSt-NHC-Ni shows a slow and graduate decay, crossing the 25% decomposition level only after 240 hours. pSt-NHC-Au, which has the least oxophilic metal tested, shows minimal metal leaching, crossing 5% only after 200 hours. These data indicate that these metallopolymers are significantly more stable than any QA tested under these harsh alkaline and dry non-aqueous conditions.

Without being bound by any particular theory, it is suggested that the difference in stability of the tested metallopolymers is related to hydroxide interaction with the metal cation, and results from the difference in the metal's oxophilicity, which may lead to the weakening of the ligand-metal bond, and eventually to scission.

### Example 3

### Metallopolymer-Containing AEM

A 4 cm×2 cm membrane containing pSt-NHC-Au was prepared by solvent casting from toluene in the glovebox, using polytetrafluoroethylene molds (100 μm thickness was obtained), as described in Example 1 hereinabove. After a partial exchange of the chlorides (derived from the gold salt and from the polymer) to hydroxide by exposure to a 1M aqueous NaOH solution, the membrane anion conductivity was tested using a previously reported ex-situ conductivity method [Ziv, N., and Dekel, D. R. (2018) Electrochem. Commun. 88, 109-113].

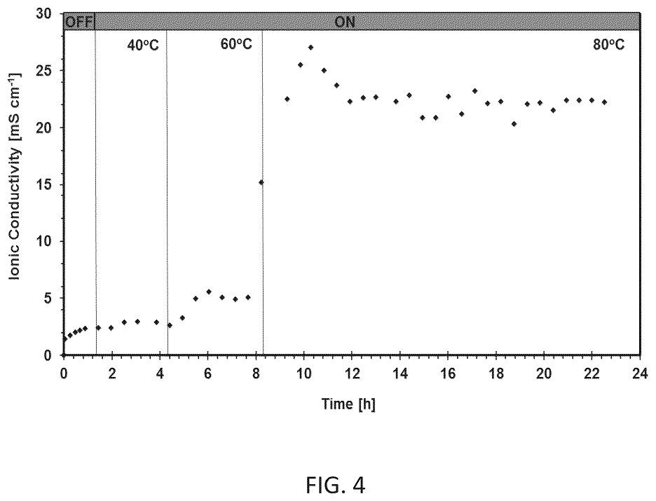

The obtained data is shown in FIG. 4. The OH⁻ conductivities (95% RH) were found to be 3, 5, and 22 mS cm⁻¹ when tested at 40, 60 and 80° C., respectively.

Although these values are lower than QAs due to the stronger metal-anion binding, the improved stability obtained by the metallopolymers described herein allows using higher operating temperatures, and hence to a higher power output.

### Example 4

### AEMFC Fabrication and Testing

Pivoting from the promising true OH⁻ conductivity results, a 2×2 cm piece of the pSt-NHC-Au membrane that was originally soaking in Milli-Q water was transferred to 1 M aqueous KOH solution for 7 days at room temperature, in order to ensure maximum conversion to hydroxide form. One square centimeter gas diffusion electrodes of PtRu/C and Pt/C were made according to previously reported procedures.

The gas diffusion electrode method was employed to prepare the anode and cathode electrodes for AEMFC testing, following general procedures as described, for example, in Huang et al. (2020) J. Memb. Sci. 597, 117769; Singh et al. (2020) Adv. Funct. Mater., 30, 2002087; and Douglin et al. (2020) J. Power Sources Adv. 5, 100023.

In brief, for the anode, 7 mg of PtRu/C catalyst was combined with 3 mg of AEI and 4 mg of Vulcan XC 72 carbon and ground with a mortar and pestle. Carbon was added to increase the pore volume and avoid flooding. One-part of deionized water and five-parts of isopropanol were added to the mixture and further ground to create a slurry. For the cathode, Pt/C catalyst was prepared in a similar manner to the anode, but without the addition of carbon black. Gas diffusion layers were cut for the anode and cathode, to an active area size of 1 cm². After ultra-sonicating the inks at 180 W, 37 kHz for 1 hour in a Elmasonic P 60 H ultrasonic bath filled with water and ice to keep the temperature below 10° C., they were sprayed directly onto the gas diffusion layers with an Iwata HP-TH professional airbrush. The anode and cathode were loaded to 0.94 mg_{Ptru} cm⁻² and 0.73 mg_{Pt} cm⁻², respectively.

The electrodes were immersed in aqueous 1 M KOH solution for 1 hour, with solution changes every 20 minutes, to convert to hydroxide form. Following this, the electrodes along with a 4 cm² piece of the pSt-NHC-Au AEM were assembled in-situ between two 5 cm² single-serpentine graphite bipolar flow field plates and pressed using a 1.5 N m torque.

The thus obtained H₂/O₂ AEMFC was tested in an 850e Scribner Associates Fuel Cell test station. The cell temperature was first heated up while flowing N₂ at 0.05 slpm and allowed to stabilize at 45° C., then fed with pure, fully-humidified H₂ and O₂ reactant gases at flow rates of 0.15 slpm without back-pressurization. A polarization curve of the AEMFC was recorded at a scan rate of 10 mV s⁻¹ (fast test to capture beginning-of-life performance to mitigate against any degradation-related power loss). Following the acquisition of the polarization curve, the cell temperature was increased to 65° C. while maintaining full humidification, and additional polarization curves were taken at 5° C. intervals (at 45, 50, 55 and 60° C.).

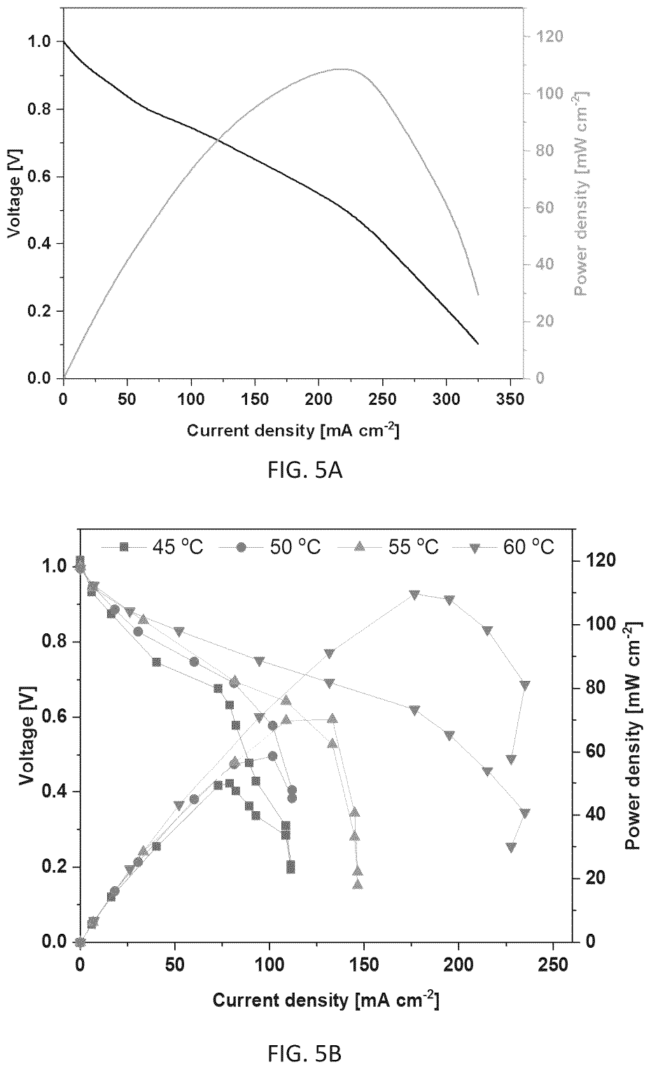

The obtained data is presented in FIGS. 5A and 5B and show that the tested AEMFC exhibits an elevation in performance and operational stability as temperature increased, with the best performance measured at 65° C., with a peak power density of 113 mW/cm² and a limiting current density of 325 mA/cm², indicating a good performance, and potential benefits of the metallopolymer-based ion-exchange membrane as disclosed herein.

### Example 5

### Metallopolymers Coordinated by Oligopyridines

A series of nickel-metallopolymers coordinated by oligopyridines were synthesized using commercially available hydroxymethyl norbornene and halogen-substituted pyridines, according to procedures such as described in Kwasny & Tew [J. Mater. Chem. A (2017) 5, 1400-1405], Zha et al. [J. Am. Chem. Soc. (2012) 134, 4493-4496] and Aggarwal et al. [Macromol. Rapid Commun. (2021) 2021, 2100238]. Chemical syntheses were performed using monodentate (mono-pyridine; MP), bidentate (bi-pyridine; BP) and tridentate (ter-pyridine; TP) ligands, as depicted schematically in FIG. 6.

Monomer (MP, BP, or TP; quantities are mentioned in Table 3) and dicyclopentadiene (DCPD) were dissolved in a minimal amount of chloroform (0.7 mL) in a vial. NiCl₂·6H₂O was dissolved in methanol (0.2 mL) in a separate vial. Both solutions were mixed together and then 2^{nd} generation Grubbs' catalyst (0.001 equivalents) in chloroform (0.1 mL) was added to the solution, which was stirred vigorously for 1 min at room temperature (before the addition of Grubbs' catalyst, triethyl phosphite (0.01 mL) was added to reduce the polymerization rate at room temperature) and then transferred to a pre-heated (to about 45° C.) polytetrafluoroethylene mold (40×20×0.1 mm) to obtain a thin membrane. Solvent evaporation pace was slowed by covering the mold. After the formation of the membrane, it was washed several times with methanol to remove unreacted reagents and byproducts.

Table 3 presents quantities (in mmol) of monomers, NiCl₂·6H₂O and DCPD used to synthesize each polymer.

TABLE 3

| | NiCl₂•6H₂O | MP | BP | TP | DCPD |
|---|---|---|---|---|---|
| Polymer | (mmol) | (mmol) | (mmol) | (mmol) | (mmol) |
| p-MP | 0.25 | 0.50 | 0 | 0 | 2.48 |
| p-BP | 0.18 | 0 | 0.36 | 0 | 1.79 |
| p-TP | 0.14 | 0 | 0 | 0.28 | 1.41 |
| p-(MP)(BP)(TP) | 0.25 | 0.25 | 0.25 | 0.25 | 1.25 |
| p-(MP)₂(BP)₂ | 0.12 | 0.25 | 0.25 | 0 | 2.48 |
| p-(MP)₃(TP) | 0.14 | 0.42 | 0 | 0.14 | 0.71 |
| p-(MP)₄(BP) | 0.12 | 0.50 | 0.12 | 0 | 0.62 |

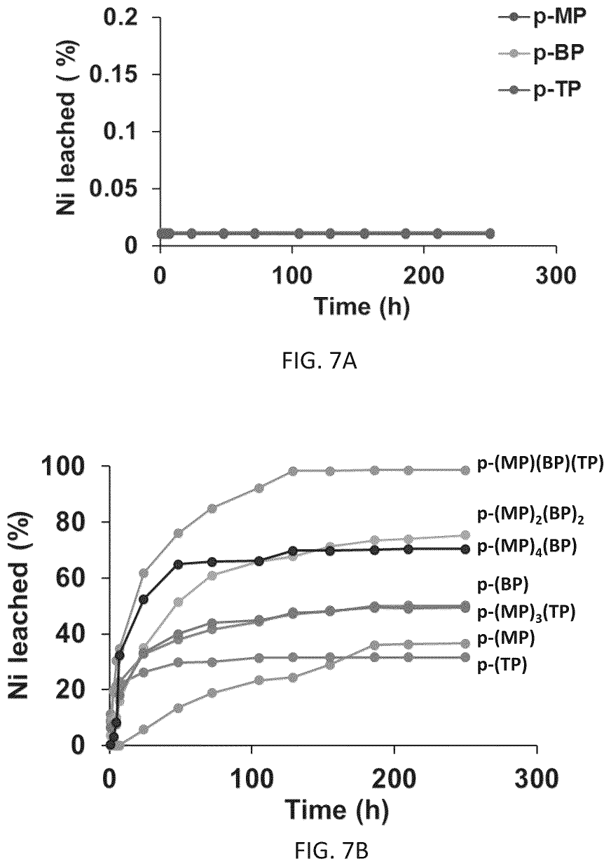

Stability: Two tests were performed, one in methanol and the other in DMSO, using procedures such as described in Example 2. The results for the first stability test are presented in FIG. 7A. It can be seen that the polymers pMP, pBP and pTP show no nickel leaching in methanol, even after 250 hours. The polymers were then subjected to more aggressive conditions in KOH/DMSO, and the results are presented in FIG. 7B. Lower stabilities can be observed under these harsher conditions, with higher decomposition degrees obtained for all examined compounds. 100% leaching was obtained for p(MP)(BP)(TP) after 120 hours, indicating its low alkaline stability compared to other metallopolymers from this exemplary series under these conditions. The polymer based on a single-type ligand, p(TP), showed the lowest degree of decomposition with only 30% nickel leaching even after 250 hours of exposure to these harsh conditions.

IEC: theoretical and experimental IEC values were determined using chloride titration with AgNO₃, using procedures such as described in Example 1. The results are presented in Table 4. For metallopolymers with a single ligand type (p-MP, p-BP, p-TP), the IEC experimental values are quite close to the calculated ones. However, the metallopolymers with a mixture of ligands showed higher experimental IEC values than calculated values, indicating that highly coordinated complexes were not formed. ICP analyses were also performed, which indicated the most likely composition of each single-ligand complex: pMP is mainly Ni(MP)₂Cl₂; pBP is both Ni(BP)Cl₂ and Ni(BP)₂Cl₂; pTP is mainly [Ni(TP)₂]²⁺.

WU: Given the major differences in alkaline stability described herein, additional properties were measured for the most stable (pMP and pTP) and least stable (p(MP)(BP)(TP)) metallopolymer AEMs. WU was measured in the Cl⁻ form at 95% RH at 40° C. Three exemplary compounds were tested, as shown in Table 4. Water uptake and water uptake kinetics were measured [based on procedures which are described in, for example, Zheng et al. Macromolecules 2018, 51, 3264], given the high importance of water in the AEM ion-conductivity and alkaline stability. Contrary to alkaline stability, the two most stable metallopolymer AEMs (pMP and pTP) showed lower water uptake (5.62% and 9.29% respectively) compared to the least stable metallopolymer, p(MP)(BP)(TP) which showed the highest water uptake of 14.20% (at 45° C. and 95% relative humidity). This higher value, however, is probably a consequence of the higher IEC of this metallopolymer AEM. Higher IEC indicates the presence of larger amounts of hygroscopic chloride ions. On the other hand, the water uptake characteristic time constant (τ) indicated that the most stable metallopolymer AEMs absorb water significantly faster than p(MP)(BP)(TP).

Chloride ion conductivity: Chloride ion conductivity (a) was measured at 90% RH and 60° C. for the 3 exemplary polymers. The data, presented in Table 4, shows significant differences that do not correlate to IEC. pMP, with the lowest water uptake, showed 8.71 mS/cm conductivity under these test conditions. p(MP)(BP)(TP), which exhibited the highest IEC and water uptake, showed a moderate conductivity of 2.81 mS/cm. Finally, pTP showed the lowest conductivity, 1.99 mS/cm.

TABLE 4

| | | | | WU | |
|---|---|---|---|---|---|
| | | | | charac- | Conduc- |
| | IEC_{Theoretical} | IEC_{Ag} | | teristic | tivity |
| | (mmol/ | (mmol/ | WU | time (τ) | σ (Cl⁻) |
| Polymer | gram) | gram) | (%) | (minutes) | (mS/cm) |
| p-MP | 1.06 | 0.94 | 5.62 | 7.93 | 8.71 |
| p-BP | 0.93 | 1.01 | — | — | — |
| p-TP | 0.87 | 0.93 | 9.29 | 14.93 | 1.99 |
| p- | 1.10 | 1.50 | 14.20 | 38.97 | 2.81 |
| (MP)(BP)(TP) | | | | | |
| p-(MP)₂(BP)₂ | 0.79 | 1.27 | — | — | — |
| p-(MP)₃(TP) | 1.04 | 1.35 | — | — | — |
| p-(MP)₄(BP) | 0.95 | 1.26 | — | — | — |

Information from small molecule studies on nickel-pyridine complexes can help to explain the different stabilities of the different metallopolymers, despite the presence of the same backbone under the same alkaline conditions. Two potentially important factors are: a) kinetic stabilization due to ligand valence; and b) binding strength, which can be estimated based on N—Ni bond lengths.

p-TP, the most stable metallopolymer at the end of alkaline treatment, is predominantly ligated by two TP ligands, i.e., nickel is hexacoordinated, contrary to other TP-containing metallopolymers. This is a consequence of the excess ligand to nickel in the metallopolymer preparation. In this particular case, the chelate effect is the dominating factor as relatively high stability is also observed for p-(MP)₃(TP), in which the nickel complex is also hexacoordinated [Ni(MP)₃(TP)]²⁺·2Cl⁻. However, in p-(MP)(BP)(TP), this stability is not observed, apparently because this polymer contains nickel complexes where the metal presents lower coordination numbers (3 or 4).

Regarding polymers with MP or BP ligands, the chelate effect appears to be less significant. Ni/N weight % ratio indicated the formation of Ni(MP)₂Cl₂ complexes in p-MP, whereas Ni(BP)₂Cl₂ complexes were predominant in p-BP. Ni—N bond lengths are quite different in Ni(II) pyridine and bipyridine complexes. For example, in trans-bis(2,6-dimethylpyridine)nickel(II) chloride, the Ni—N bond length is 1.935□, whereas in cis-bis(2,2′-bipyridine)nickel(II) chloride, the distance is 2.084□ [Darby et al., Inorganica Chim. Acta 1992, 194, 113; Fontaine, Acta Crystallogr. Sect. E Struct. Reports Online 2001, 57, m270; Eggleston et al., Inorg. Chem. 1985, 24, 4573]. These significantly longer Ni-N bond distances can explain why p-BP was less stable than p-MP under harsh alkaline conditions.

The metallopolymers with mixed MP and BP ligands, p-(MP)₄(BP) and p-(MP)₂(BP)₂, presented similar metal leaching profiles. p-(MP)₄(BP) consisted mostly of [Ni(MP)₄(BP)]²⁺·2Cl complex, as indicated by the Ni/N weight % ratio, whereas no single set showed a good fit for p-(MP)₂(BP)₂. Still, both these metallopolymers exhibited relatively low stability under strongly alkaline conditions, supporting the conclusion that the BP ligand, which has longer Ni—N bonds, is associated with low alkaline stability.

Taken together, the above results indicate that bond length may be the dominating factor. Metallopolymers with ligand mixtures tend to be less stable due to the formation of complexes with lower coordination numbers.

Comparison of different properties of exemplary metallopolymers indicated that the properties of alkaline stability, ion-conductivity, and water uptake in metallopolymer AEMs are relatively independent of one another. This indicates the potential of metallopolymers with optimal balances between alkaline stability and other properties such as ion conductivity, as well as tailoring metallopolymers for particular applications. For example, for an application where stability is particularly crucial, a metallopolymer with particularly high stability and moderately high conductivity may be selected; whereas for an application where stability is less crucial, a metallopolymer with moderately high stability and particularly high conductivity may be selected.

### Example 6

### Screening NHC Ligands for Metallopolymers

NHC ligands are strong σ-donors and poor π-acceptors, therefore they allow strong ligand-to-metal binding with very little tendency to dissociate.

As depicted in FIG. 8, a series of gold metallopolymers with different NHC ligands was synthesized and characterized. This synthesis is similar to that described in Example 1 (and depicted in FIG. 2), but differs in that a variety of ligands were used. These mesityl N-heterocyclic ligands provided the final polymer with different steric and electronic properties. The ligands were selected from I (1-mesityl imidazole; described in Example 1), B (1-mesityl-1H-benzoimidazole), P (1-mesityl-1,4,5,6-tetrahydrop yrimidine), N (1-mesityl-4,5-dihydro-1H-imidazole) and T (4-mesityl-4H-1,2,4-triazole). Using ligand P or N potentially provides two possible complexes, as described in Tables 5 and 6. The generated polymers are written in the form of pSt-VB-L-Au, where “VB” stands for ethyl benzyl (originating from VBC), and “L” is the specific ligand used.

The molar ratio of Au, Cl and N was assessed by measurement of the weight % of the elements in each of the metallopolymers using inductively-coupled plasma spectrometry (ICP). First, in order to consider the oxidation state of the gold centers, the ratio of Au to Cl was examined. If the reaction and exposure to the environment does not affect the Au(III) expected oxidation state, a mass ratio of 1.85 would be expected. However, if gold is reduced to the more stable Au(I), the theoretical weight % ratio between the atoms would be expected to be 5.56. Anything between these values would indicate a mixture of the two oxidation states.

As shown in Table 5 below, metallopolymers PS-VB-I-Au, PS-VB-B-Au, PS-VB-T-Au and PS-VB-N-Au presented values quite close to 1.85, indicating that the Au(III) oxidation state was maintained. PS-VB-P-Au, on the other hand, presented a ratio of 4.55, indicating that most of the gold atoms in this metallopolymer were reduced to Au(I).

TABLE 5
Weight percentage of Au, N and Cl atoms in
exemplary polymers, as determined by ICP.

| | | | | % Au: | % Au: | Apparent |
|---|---|---|---|---|---|---|
| Polymer | % Au | % N | % Cl | % Cl | % N | complex |
| PS-VB-I-Au | 25.51 | 3.51 | 13.55 | 1.88 | 7.27 | NHC-AuCl₃ |
| PS-VB-B-Au | 25.71 | 3.61 | 14.14 | 1.82 | 7.12 | NHC-AuCl₃ |
| PS-VB-P-Au | 18.83 | 2.65 | 4.14 | 4.55 | 7.10 | NHC- |
| | | | | | | AuCl/NHC- |
| | | | | | | AuCl₃ |
| PS-VB-N-Au | 24.14 | 4.69 | 12.61 | 1.91 | 5.14 | NHC-AuCl₃/ |
| | | | | | | [NHC₂-AuCl₂]Cl |
| PS-VB-T-Au | 27.12 | 5.86 | 17.59 | 1.54 | 4.62 | NHC-AuCl₃ |

In addition, the gold to ligand ratio was determined by comparing the ratio of gold atoms to nitrogen atoms in the metallopolymers. For a single NHC ligand per gold center, a theoretical weight % of 7.04 would be expected for all ligands except for PS-VB-T-Au, in which the expected weight % would be 4.69. If two NHCs are coordinating the gold atoms, the Au:N weight % ratio would be expected to decrease to 3.51 for all ligands, and to 2.34 for PS-VB-T-Au.

As further shown in Table 5, the determined weight % values were quite close to the predicted values for a mono-NHC coordination, except in the case of PS-VB-N-Au, which showed an intermediate value, indicating that this metallopolymer includes some doubly coordinated gold atoms.

Stability, IEC, WU and conductivity tests were performed in order to evaluate the suitability of the exemplary metallopolymers for use as AEMs. Theoretical and experimental IEC values were obtained using (a) ICP, (b) ¹H NMR and (c) chloride titration with AgNO₃, according to procedures such as described hereinabove, for example, in Example 1. The IEC values for the N-heterocyclic metallopolymers are presented in Table 6.

TABLE 6

| | | IEC from | IEC from | |
|---|---|---|---|---|
| | | ICP | ¹H NMR | IEC from |
| | | (mmol/ | (mmol/ | titration |
| Polymer | Complex | gram) | gram) | (mmol/gram) |
| pSt-VB-I-Au | NHC-AuCl₃ | 3.81 | 3.53 | 3.12 |
| pSt-VB-B-Au | NHC-AuCl₃ | 3.98 | 3.34 | 2.55 |
| pSt-VB-P-Au | NHC-AuCl/ | 1.16 | 3.47-1.26 | 1.05 |
| | NHC-AuCl₃ | | | |
| pSt-VB-N-Au | NHC-AuCl₃/ | 3.55 | 2.15-3.52 | 2.25 |
| | [NHC₂- | | | |
| | AuCl₂]Cl | | | |
| pSt-VB-T-Au | NHC-AuCl₃ | 4.95 | 3.53 | 2.92 |

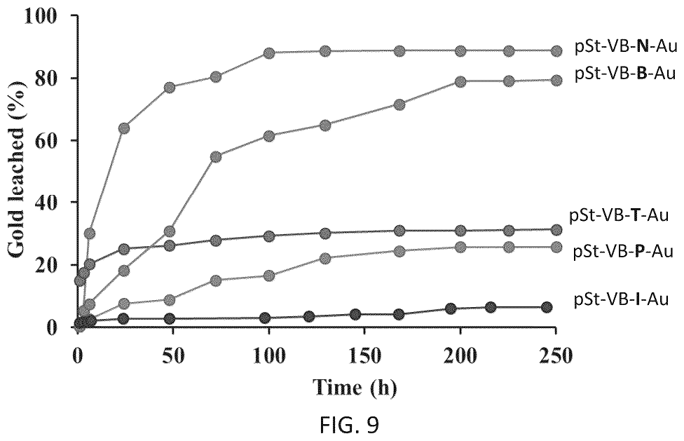

Stability tests were performed using the method described in Example 2, and the results for gold leaching over time are presented in FIG. 9, showing that the lowest degree of leaching occurs with the polymer based on ligand I.

Water uptake (WU) of the metallopolymers (in the Cl⁻ form) was determined at 95% relative humidity and 40° C. (percentage WU and WU characteristic time (T)); and chloride conductivity (σ) was determined at 95% relative humidity and 60° C. The results are summarized in Table 7 below.

TABLE 7

| | | Water uptake | |
|---|---|---|---|
| | | characteristic | Cl⁻ ion |
| | Water uptake | time (τ) | conductivity |
| Polymer | (%) | (minutes) | (mS/cm) |
| PS-VB-I-Au | 162.13 | 480.11 | 3.07 |
| PS-VB-B-Au | 79.79 | 338.98 | 2.99 |
| PS-VB-P-Au | 87.47 | 194.12 | 0.55 |
| PS-VB-N-Au | 153.72 | 417.68 | 0.55 |
| PS-VB-T-Au | 130.41 | 203.84 | 2.25 |

Two structural features of the metallopolymers can be taken into consideration when examining the results obtained; the structure of the NHC and the type of the complex.

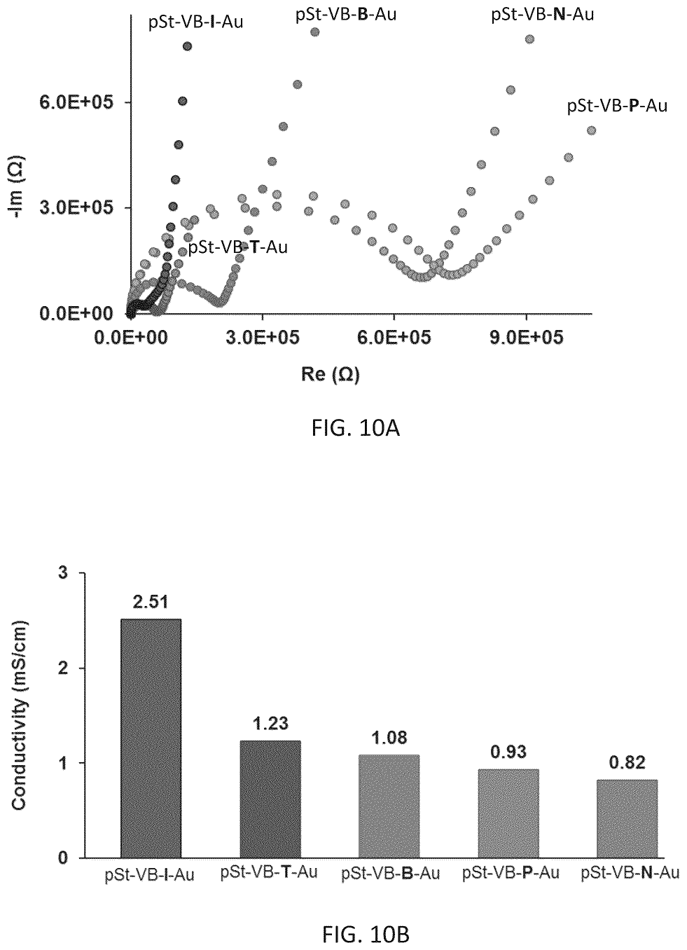

The resistance of the membranes was further characterized using electrochemical impedance spectroscopy to obtain the resistance of the membrane from the Nyquist plot, and the data are presented in FIG. 10A. Using this technique, it was found that the conductivity of unsaturated NHC complexes (I, T, B) exhibits higher conductivity than saturated carbene complexes (N, P), with pSt-VB-I-Au exhibited the highest conductivity; which is consistent with both the chloride conductivity values presented in Table 7, and values for IEC (experimentally determined by titration). pSt-VB-I-Au exhibited the highest conductivity of 2.51 mS/cm followed by pSt-VB-T-Au with the conductivity of 1.23 mS/cm and pSt-VB-B-Au with 1.08 mS/cm (FIG. 10B). pSt-VB-N-Au exhibited conductivity of 0.93 mS/cm followed by pSt-VB-P-Au with 0.82 mS/cm.

These results indicate that conductivity of metallopolymers depends on the ligand type and the type of ligand-metal complex formed in the metallopolymer.

In view of the low oxophilicity of gold, interactions of the metal with hydroxide are unlikely to play an important role in the observed difference in alkaline stability of the different exemplary metallopolymers, particularly in view of the fact that the metallopolymers comprised the same metal (as well as the same polymer backbone). This suggests that hydroxide attack on the ligand is responsible for the observed differences in stability.

As discussed hereinabove with regard to pyridine-nickel complexes, the Au—C_{carbene} bond length reflects the strength of the metal-ligand interaction. PS-VB-I-Au (comprising NHC-AuCl₃ complexes) is the most stable of the tested metallopolymers, suggesting that the Au—C_{carbene} bond is particularly strong; and this is consistent with IMes-AuCl₃ being reported to present one of the shortest Au—C_{carbene} bond lengths, 1.977 Å, as compared, for example, to 2.013 Å and 1.993 Å for SIMes-AuCl₃ complex (such as present in PS-VB-N-Au) and PyMes-AuCl complex (such as in PS-VB-P-Au), respectively [Gaillard et al., Organometallics 2009, 29, 394-402; Wen et al., Arkivoc 2005, 2005, 169-174]. In addition, Au—C_{carbene} bond lengths of 1.989 and 2.004 Å have been reported for benzimidazole-NHC complexes (similar to that of PS-VB-B-Au) bearing various N-substituents ci et al., Chem.—A Eur. J. 2017, 23, 7809-7818; Huynh et al., Organometallics 2013, 32, 4591-4600]; and a triazole-based NHC-AuCl₃ complex (similar to that of PS-VB-T-Au), was reported to present a 2.009 Å Au—C_{carbene} bond length [Levchenko et al., Dalt. Trans. 2020, 49, 3473-3479]. The aforementioned bond lengths indicate that the relatively high stability of PS-VB-B-Au and Tri-PS-VB-T-Au (as compared to PS-VB-N-Au and PS-VB-P-Au) is associated with the shorter Au—C_{carbene} bond lengths for benzimidazole- and triazole-based complexes (e.g., as compared to SIMes-AuCl₃ complex).

### Example 7

### Additional NHC-Containing Backbones for Metallopolymers

Further studies were conducted with an NHC polymer based on 1-mesityl-imidazole (NHC ligand I)

Three additional polymers were prepared using a variety of backbones in the presence of the NHC ligand I, 1-mesityl imidazole.

### Preparation of a Poly(Phenylene Oxide)-Based NHC Backbone

### Synthesis of Brominated Poly(Phenylene Oxide) (BPPO)

Brominated poly(phenylene oxide) (BPPO) was prepared from poly(phenylene oxide) (PPO) as depicted schematically below:

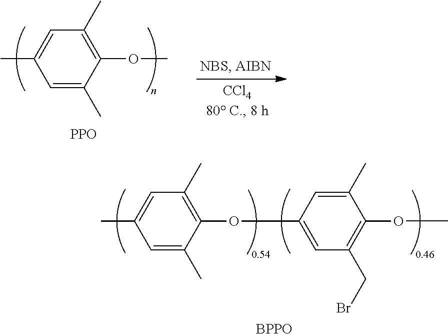

In a 250 mL round-bottom flask, PPO (12 grams, 100 mmol) was dissolved in carbon tetrachloride (100 mL). N-bromosuccinimide (NBS, 8.9 grams, 50 mmol) and 2,2′ -azobis-isobutyronitrile (0.5 gram, 3 mmol). The mixture was refluxed (80° C.) for 5 hours. After cooling, the reaction mixture was poured into a 10-fold excess of ethanol to allow precipitation of the product. The polymer was filtered and washed with ethanol, and the residue subsequently re-dissolved in chloroform (120 mL) and precipitated into a 10-fold excess of ethanol solution. The polymer was collected as a light brown powder and dried under vacuum for overnight to obtain BPPO. Yield: 14.10 grams, 90%, bromination ratio: 46% (DS=0.46)

### Synthesis of Functionalized Poly(Phenylene Oxide) Polymer with 1-Mesityl Imidazole (BPPO-I)

Brominated poly(phenylene oxide) (BPPO) obtained as described hereinabove was reacted with 1-mesityl-imidazole (ligand I) to obtain a functionalized polymer (BPPO-I), as depicted schematically below:

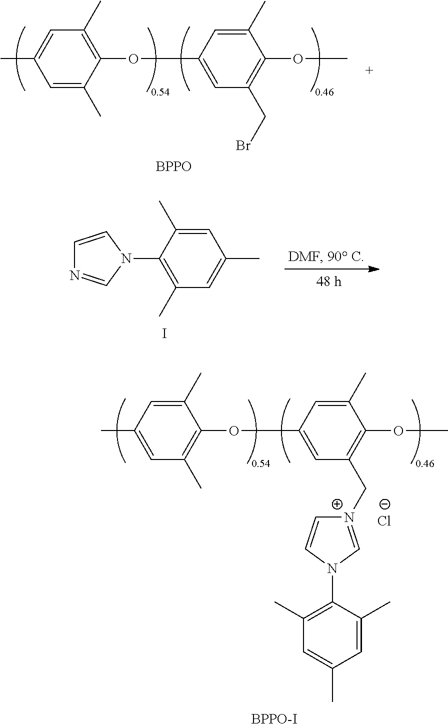

In a 50 mL round bottom flask, BPPO (1 g, 2.94 mmol of bromine-containing monomeric units) was dissolved in DMF (10 mL). N-mesityl imidazole (0.82 gram, 4.41 mmol) was then added and the reaction mixture was stirred at 90° C. for 48 hours. After the completion of the reaction (determined by ¹H NMR), the product was precipitated in diethyl ether. The precipitate was re-dissolved in a minimal amount of dichloromethane and re-precipitated in hexane. The pure product BPPO-I was obtained as a light brown solid. Yield: 1.22 grams, 85%.

### Preparation of Fluorinated Aryl NHC Backbone

### Synthesis of 7-Bromo-1,1,1-Trifluoroheptan-2-One (BTH)

A functionalized fluorinated ketone was prepared from an acyl chloride, as depicted schematically below:

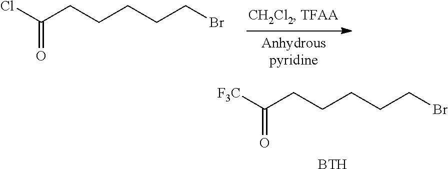 [SMILES: O=C(Cl)CCCCCBr ; O=C(CCCCCBr)C(F)(F)F ; "BTH"]

6-bromohexanoyl chloride (1.0 mL, 6.53 mmol) was dissolved in anhydrous dichloromethane (50 mL). Trifluoroacetic anhydride (5.44 mL, 39.18 mmol) was added slowly to the stirring solution. Anhydrous (anhyd.) pyridine (4.2 mL, 52.24 mmol) was added dropwise and the resulting solution stirred at 25° C. for 2 hours. The reaction was cooled to 0° C. and quenched by dropwise addition of water (20 mL), followed by warming to 25° C. The reaction mixture was partitioned between water (100 mL) and dichloromethane (300 mL). The organic layer was washed with 1 N aqueous HCl (100 mL) followed by concentration under reduced pressure. Chromatography (SiO₂, 1:2 ethyl acetate/hexane) afforded the product BTH as a red oil. Yield: 0.640 gram, 41%.

¹H NMR (CDCl₃, 400 MHz) δ (ppm)=3.44; (t, J=6.6 Hz, 2H), 2.77; (t, J=7.2 Hz, 2H), 2.00-1.84; (m, 2H), 1.81-1.68; (m, 2H), 1.64-1.48; (m, 2H).

HRMS: m/z 246.9937 (M+H⁺, C₇H₁₀BrF₃O 246.9940).

### Synthesis of Poly(Biphenyl Alkylene) (PBPA)

The functionalized fluorinated ketone (BTH) obtained as described hereinabove was reacted with biphenyl to obtain a fluorinated biphenyl alkylene (PBPA), as depicted schematically below:

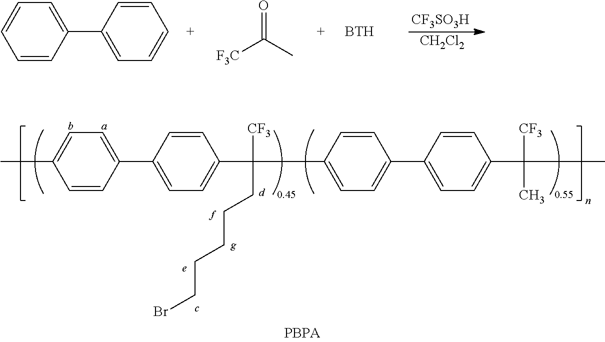

A mixture of BTH (0.40 gram, 1.62 mmol), 1,1,1-trifluoroacetone (0.19 gram, 1.69 mmol), biphenyl (0.50 gram, 3.24 mmol), dichloromethane (2.5 mL) and trifluoromethanesulfonic acid (2.3 mL) was stirred at room temperature under nitrogen atmosphere. After 3 hours, the reaction mixture solution became highly viscous and stirring continued for additional 2 hours. The resulting dark-brown, gel-like mass was then shredded with sonication and poured slowly into methanol. White fiber formed was filtered and washed with hot methanol. After drying under vacuum, the product PBPA was obtained as a white fiber-like solid. Yield: 0.94 gram, 98%.

¹H NMR (CDCl₃, 400 MHz): δ (ppm)=7.58-7.53; (H_{b}), 7.38-7.34; (Hₐ), 3.32; (H_{c}), 2.45; (H_{d}), 1.98; (CH₃), 1.79; (Hₑ), 1.45; (H_{f}), 1.25; (H_{g}).

¹⁹F NMR (CDCl₃, 400 MHz): δ (ppm)=−66; (s, CF₃), −69; (s, CF₃).

### Synthesis of Imidazolium Functionalized PBPA (PBPA-I)

The fluorinated PBPA obtained as described hereinabove was reacted with 1-mesityl-imidazole (ligand I) to obtain a functionalized polymer (PBPA-I), as depicted schematically below:

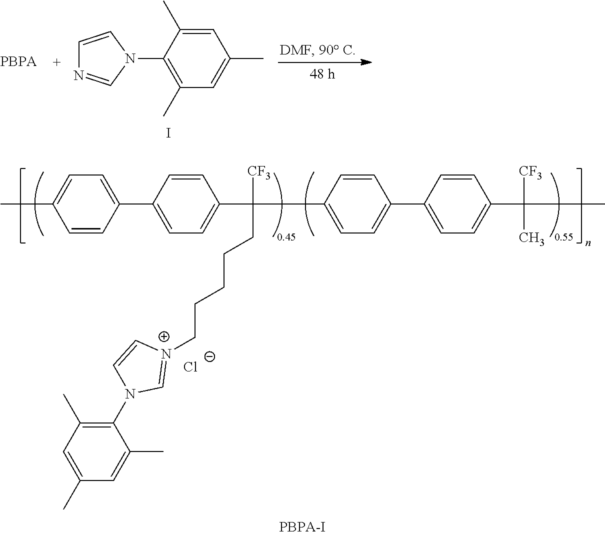

In a 50 mL round bottom flask, PBPA (1 gram, 1.45 mmol of bromine-containing monomeric units) was dissolved in DMF (10 mL). N-mesityl imidazole (0.406 gram, 2.18 mmol) was then added and the reaction mixture was stirred at 90° C. for 48 hours. After the completion of the reaction (determined by 1 H NMR), the product was precipitated in diethyl ether. The precipitate was re-dissolved in a minimal amount of dichloromethane and re-precipitated in hexane. The pure product PBPA-I was obtained as a light brown solid. Yield: 1.10 grams, 80%.

### Preparation of Polysulfone NHC Backbone

### Synthesis of Chloromethyl Functionalized Polysulfone (CPSU)

Cholormethyl-functionalized polysulfone (CPSU) was prepared from polysulfone (PSU) as depicted schematically below:

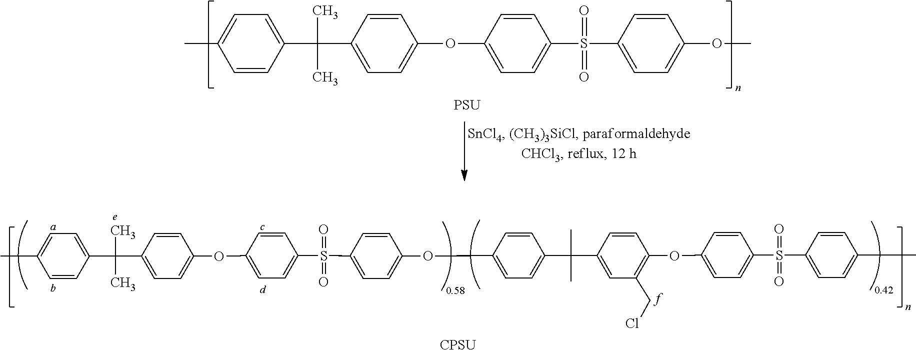

In a 500 mL two-neck round bottom flask, PSU (3.7 gram) and paraformaldehyde (2.6 grams, 85.5 mmol) were stirred in anhydrous chloroform (250 mL) in a two-necked flask under argon atmosphere. After the complete dissolution, trimethylsilyl chloride (10.8 mL, 85.5 mmol) and SnCl₄ (0.1 mL, 0.85 mmol) were slowly added dropwise. The reaction was stir at 60° C. in the argon atmosphere for another 12 hours. The mixture was transferred to methanol (400 mL) and was allowed to settle at room temperature for a few hours. The obtained white solid was filtered, repeatedly washed with water and dried under vacuum.

¹H NMR (CDCl₃, 400 MHz): δ (ppm)=7.90-6.80; (Hₐ, H_{b}, H_{c}, H_{d}), 4.55; (H_{f}), 1.71; (Hₑ).

### Synthesis of Imidazolium Functionalized Polysulfone (CPSU-I)

The cholormethyl-functionalized polysulfone (CPSU) obtained as described hereinabove was reacted with 1-mesityl-imidazole (ligand I) to obtain a functionalized polysulfone (CPSU-I), as depicted schematically below:

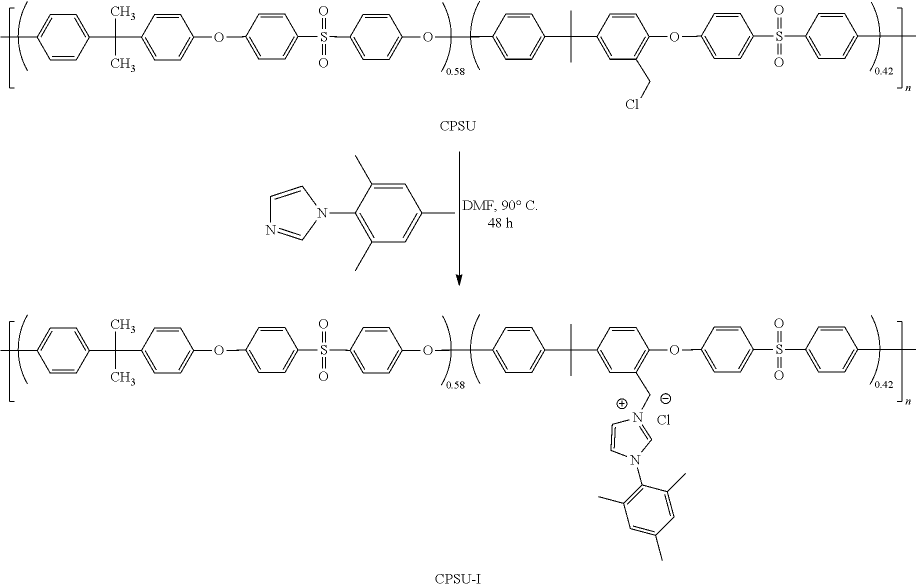

In a 50 mL round bottom flask, CPSU (1 gram, 0.92 mmol of bromine-containing monomeric units) was dissolved in DMF (10 mL). N-mesityl imidazole (0.257 gram, 1.38 mmol) was then added and the reaction mixture was stirred at 90° C. for 48 hours. After the completion of the reaction (determined by ¹H NMR), the product was precipitated in diethyl ether. The precipitate was re-dissolved in a minimal amount of dichloromethane and re-precipitated in hexane. The pure product was obtained as a light brown solid. Yield 1.05 gram, 75%.

### Preparation of Imidazolium Functionalized HDPE (High Density Polyethylene)

In a 50 mL round bottom flask, an HDPE membrane (about 10 μm in thickness and about 15 mg in weight) grafted with poly(vinyl benzyl chloride) (poly(VBC)) was added to DMF (10 mL). N-mesityl imidazole (0.257 gram, 1.38 mmol) was then added and the reaction mixture was heated to 90° C. for 72 hours. The polymer was repeatedly washed with water and dried.

### Functionalization of Different Backbones with Gold

The abovementioned polymers were treated with gold to generate gold metallopolymer-containing AEMs.

In a 10 mL vial in a glove-box, an imidazolium functionalized polymer (100 mg) was dissolved in dry DMF (2 mL) (HDPE was added to DMF but dis not dissolve). Potassium tert-butoxide (1.5 equivalents with respect to the imidazolium groups) dissolved in minimal amount of THF (ca. 0.2 mL) was added and the reaction was stirred at room temperature for 20 minutes. KAuCl₄ (1.5 equivalents with respect to the imidazolium groups) dissolved in a minimal amount of acetonitrile (0.2 mL) was then added. The reaction mixture was stirred for additional 8-10 minutes and then poured into 4 cm×2 cm polytetrafluoroethylene molds. After complete evaporation of the solvent, the membrane was removed and repeatedly washed with deionized water to ensure removal of byproducts.

In order to examine the preformance of exemplary gold-metallopolymers described herein, the metallopolymer(s) is assessed by determining stability under alkaline conditions, IEC, conductivity and/or WU, according to procedures such as described hereinabove.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-49. (canceled)

50. A polymeric ion conductor comprising a polymeric or co-polymeric backbone which comprises a plurality of backbone units, a metal ligand attached to at least a portion of said backbone units, and a metal ion attached to said metal ligand, wherein said metal features an oxophilicity lower than 0.4 when calculated according to metal-oxygen bond enthalpy.

51. The polymeric ion conductor of claim 50, wherein said metal is selected from nickel (Ni), zinc (Zn), palladium (Pd), lead (Pb), silver (Ag), cadmium (Cd), platinum (Pt) and gold (Au).

52. The polymeric ion conductor of claim 50, wherein said ligand comprises at least one N-heterocyclic carbene moiety.

53. The polymeric ion conductor of claim 52, wherein said N-heterocyclic carbene moiety is represented by general Formula I: 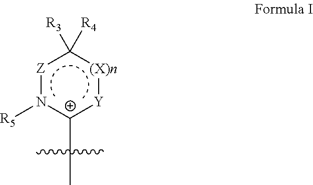
wherein:
the dashed line indicates an optional unsaturated bond;
X is —CR₆R₇—CR₈R₉— and/or —CR₁₀═CR₁₁—;
n is 0, 1 or 2, representing the number of X;
Y is —CR₁₂R₁₃—, —NR₁₄—, —S—, —O—, or absent;
Z is —CR₁R₂—, —NR₁₅—, —S—, —O—, or absent;
R₁, R₃, R₅ and R₁₅ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or is absent in case the atom substituted thereby is linked to an adjacent atom via a double bond, or, alternatively, one of R₁, R₃, R₅ and R₁₅ is a linking moiety or a bond linking the heterocyclic moiety to a backbone unit of said polymeric backbone;
R₂, R₄, R₁₂, R₁₃ and R₁₄ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or alternatively, one of R₂, R₄, R₁₂, R₁₃ and R₁₄ is a linking moiety or a bond linking the heterocyclic moiety to a backbone unit of said polymeric backbone;
R₆, R₇, R₈, R₉, R₁₀ and R₁₁ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or, alternatively, one of R₆, R₇, R₈, R9, R₁₀ and R₁₁ is a linking moiety or a bond linking the heterocyclic moiety to a backbone unit of said polymeric backbone;
and
the curved line represents an attachment point to the metal ion,
wherein at least two of R₁-R₁₅ may form a cyclic or heterocyclic ring, and
wherein at least one of R₁-R₁₅ is said linking moiety or said bond linking the heterocyclic moiety to a backbone unit of said polymeric backbone.

54. The polymeric ion conductor of claim 53, wherein said N-heterocyclic carbene moiety is represented by Formula Ia: 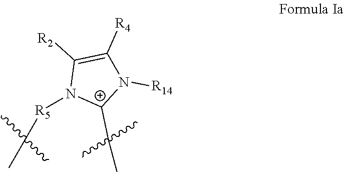
wherein R₅ is said linking moiety and the curved line next to R₅ represents an attachment point to said backbone unit.

55. The polymeric ion conductor of claim 53, wherein said N-heterocyclic carbene moiety comprises a saturated heteroalicyclic ring which includes said Y and said Z, and Y is —CR₁₄—.

56. The polymeric ion conductor of claim 50, wherein said ligand comprises at least one nitrogen-containing heterocyclic moiety, being independently substituted or unsubstituted, and a nitrogen atom of said nitrogen-containing heterocyclic moiety is coordinated to said metal.

57. The polymeric ion conductor of claim 50, wherein said ligand is a multidentate ligand which comprises at least two nitrogen-containing heterocyclic moieties, each being independently substituted or unsubstituted.

58. The polymeric ion conductor of claim 50, wherein said polymeric or co-polymeric backbone comprises in at least a portion thereof backbone units of a polystyrene or a polynorbornene.

59. A polymeric ion conductor comprising a polymeric or co-polymeric backbone which comprises a plurality of backbone units, a metal ligand attached to at least a portion of said backbone units, and a metal ion attached to said metal ligand, wherein said metal ligand comprises at least one N-heterocyclic carbene moiety represented by general Formula I: 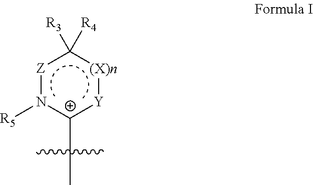
wherein:
the dashed line indicates an optional unsaturated bond;
X is —CR₆R₇—CR₈R₉— and/or —CR₁₀═CR₁₁—;
n is 0, 1 or 2, representing the number of X;
Y is —CR₁₂R₁₃—, —NR₁₄—, —S—, —O—, or absent;
Z is —CR₁R₂—, —NR₁₅—, —S—, —O—, or absent;
R₁, R₃, R₅ and R₁₅ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or is absent in case the atom substituted thereby is linked to an adjacent atom via a double bond, or, alternatively, one of R₁, R₃, R₅ and R₁₅ is a linking moiety or a bond linking the heterocyclic moiety to a backbone unit of said polymeric backbone;
R₂, R₄, R₁₂, R₁₃ and R₁₄ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or alternatively, one of R₂, R₄, R₁₂, R₁₃ and R₁₄ is a linking moiety or a bond linking the heterocyclic moiety to a backbone unit of said polymeric backbone;
R₆, R₇, R₈, R₉, R₁₀ and R₁₁ are each independently selected from the group consisting of hydrogen, alkyl, alkenyl, alkynyl, cycloalkyl, aryl, heteroaryl, cycloalkyl, heteroalicyclic, halo, hydroxy, alkoxy, aryloxy, thiohydroxy, thioalkoxy, thioaryloxy, sulfonyl, sulfonate, sulfate, cyano, nitro, azide, phosphonyl, phosphinyl, carbonyl, thiocarbonyl, a urea group, a thiourea group, O-carbamyl, N-carbamyl, O-thiocarbamyl, N-thiocarbamyl, S-thiocarbamyl, C-amido, N-amido, C-carboxy, O-carboxy, sulfonamido, guanyl, guanidinyl, hydrazine, hydrazide, thiohydrazide, and amino, or, alternatively, one of R₆, R₇, R₈, R₉, R₁₀ and R₁₁ is a linking moiety or a bond linking the heterocyclic moiety to a backbone unit of said polymeric backbone;
and
the curved line represents an attachment point to the metal ion,
wherein at least two of R₁-R₁₅ may form a cyclic or heterocyclic ring, and
wherein at least one of R₁-R₁₅ is said linking moiety or said bond linking the heterocyclic moiety to a backbone unit of said polymeric backbone.

60. The polymeric ion conductor of claim 59, wherein said metal features an oxophilicity lower than 0.4 when calculated according to metal-oxygen bond enthalpy.

61. An anion conducting composition comprising the polymeric ion conductor of claim 50 and a cyclic moiety associated therewith.

62. The anion conducting composition of claim 61, wherein said cyclic moiety is mechanically interlocked around at least a portion of said ion conductor.

63. An anion conducting composition comprising the polymeric ion conductor of claim 59 and a cyclic moiety associated therewith.

64. An anion exchange membrane comprising the polymeric ion conductor of claim 50.

65. The anion exchange membrane of claim 64, wherein said polymeric ion conductor has a cyclic moiety associated therewith.

66. An anion exchange membrane comprising the polymeric ion conductor of claim 59.

67. The anion exchange membrane of claim 66, wherein said polymeric ion conductor has a cyclic moiety associated therewith.

68. An electrochemical system comprising the anion exchange membrane of claim 64.

69. An electrochemical system comprising the anion exchange membrane of claim 66.
